(19) United States
(12) Patent Application Publication
(10) Pub. No.: US 2024/0351181 A1
(43) Pub. Date: Oct. 24, 2024

(54) RECHARGEABLE ANGLE DRILL AND RECHARGEABLE EARTH AUGER DRILL

(71) Applicant: MAKITA CORPORATION, Anjo-shi (JP)

(72) Inventors: Hidenori NAGASAKA, Anjo-shi (JP); Yuta ARAKI, Anjo-shi (JP); Ryoichi ISHIKAWA, Anjo-shi (JP); Tomohiko IMAE, Anjo-shi (JP)

(73) Assignee: MAKITA CORPORATION, Anjo-shi (JP)

(21) Appl. No.: 18/632,492

(22) Filed: Apr. 11, 2024

(30) Foreign Application Priority Data
Apr. 18, 2023 (JP) 2023-067571
Feb. 19, 2024 (JP) 2024-022706

(51) Int. Cl. B25F 5/02; B25F 5/00; E21B 11/00

(52) U.S. Cl. CPC B25F 5/02; B25F 5/001; E21B 11/005

(57) ABSTRACT

A rechargeable angle drill includes: a motor, which includes a rotor configured to rotate about a motor rotation axis, the motor rotation axis extending in an up-down direction; a motor housing part, which houses the motor; a trigger lever, which is operated to start the motor; a handle housing part, which is disposed upward of the motor housing part and in which the trigger lever is provided; a speed reduction mechanism; a gear housing part, which is disposed downward of the motor housing part and houses the speed reduction mechanism; and a rotation output part, which protrudes forward from the gear housing part and rotates about an output rotation axis orthogonal to the motor rotation axis based on a rotational force transmitted from the motor via the speed reduction mechanism. The trigger lever is disposed upward of a center of the handle housing part in the up-down direction.

### CROSS-REFERENCE TO RELATED APPLICATION(S)

The present application claims priority to and incorporates by reference the entire contents of Japanese Patent Application No. 2023-067571 filed in Japan on Apr. 18, 2023 and Japanese Patent Application No. 2024-022706 filed in Japan on Feb. 19, 2024.

### BACKGROUND OF THE INVENTION

### 1. Field of the Invention

The techniques disclosed in the present specification relate to a rechargeable angle drill and a rechargeable earth auger drill.

### 2. Description of the Related Art

In a technical field related to a rechargeable angle drill, a power tool that excavates a ground by rotating an earth auger drill bit as disclosed in JP 2020-196098 A is known.

A rechargeable angle drill may be used to form a hole using. For example, when a rechargeable angle drill is used to form a lateral hole, a loop handle and a reaction force receiving bar of an earth auger are removed, and then the work of forming the lateral hole is performed with an output shaft facing downward. For example, in piping work of installing a sewer pipe in the ground, there is a demand for a technique capable of forming a lateral hole with good operability.

One non-limiting object of the present teachings is to disclose techniques for forming a hole in an excavation target with good operability. In particular, one non-limiting object thereof is to disclose techniques for forming a lateral hole in an excavation target with good operability.

### SUMMARY OF THE INVENTION

In one aspect of the present teachings, a rechargeable angle drill may include: a motor, which includes a rotor configured to rotate about a motor rotation axis, the motor rotation axis extending in an up-down direction; a motor housing part, which houses the motor; a trigger lever, which is operated to start the motor; a handle housing part, which is disposed upward of the motor housing part and in which the trigger lever is provided; a speed reduction mechanism; a gear housing part, which is disposed downward of the motor housing part and houses the speed reduction mechanism; and a rotation output part, which protrudes forward from the gear housing part and rotates about an output rotation axis orthogonal to the motor rotation axis based on a rotational force transmitted from the motor via the speed reduction mechanism. The trigger lever may be disposed upward of a center of the handle housing part in the up-down direction.

According to the techniques disclosed in the present specification, a hole is formed in an excavation target with good operability. In particular, a lateral hole is formed in an excavation target with good operability.

### BRIEF DESCRIPTION OF THE DRAWINGS

FIG. 1 is a front perspective view illustrating a rechargeable angle drill according to a first embodiment;

FIG. 2 is a side view illustrating a main body of the rechargeable angle drill according to the first embodiment;

FIG. 3 is a cross-sectional view illustrating the main body of the rechargeable angle drill according to the first embodiment;

FIG. 4 is a side view for explaining a method of using the rechargeable angle drill according to the first embodiment;

FIG. 5 is a side view illustrating the vicinity of a trigger lever according to the first embodiment;

FIG. 6 is a side view illustrating the vicinity of a trigger lever of a rechargeable angle drill according to a second embodiment;

FIG. 7 is a view illustrating the inside of a first handle part provided with a trigger switch according to a second embodiment;

FIG. 8 is a front perspective view illustrating a rechargeable angle drill according to a third embodiment;

FIG. 9 is a rear perspective view illustrating the rechargeable angle drill according to the third embodiment;

FIG. 10 is a side view illustrating a part of the rechargeable angle drill according to the third embodiment;

FIG. 11 is an exploded perspective view illustrating a part of the rechargeable angle drill according to the third embodiment;

FIG. 12 is a cross-sectional view illustrating the rechargeable angle drill according to the third embodiment;

FIG. 13 is a front perspective view illustrating a rechargeable angle drill according to a fourth embodiment;

FIG. 14 is a perspective view illustrating the vicinity of a side handle of the rechargeable angle drill according to the fourth embodiment;

FIG. 15 is a cross-sectional view illustrating the side handle of the rechargeable angle drill according to the fourth embodiment;

FIG. 16 is a right front perspective view illustrating a rechargeable angle drill according to a fifth embodiment;

FIG. 17 is a left front perspective view illustrating the rechargeable angle drill according to the fifth embodiment;

FIG. 18 is a side view for explaining a method of using a rechargeable earth auger drill according to a sixth embodiment;

FIG. 19 is a side view illustrating the vicinity of a trigger lever of the rechargeable earth auger drill according to the sixth embodiment;

FIG. 20 is a cross-sectional view illustrating the inside of a first handle part provided with a trigger switch according to the sixth embodiment;

FIG. 21 is a cross-sectional view taken along an up-down direction passing through a pivot shaft of a link mechanism according to the sixth embodiment;

FIG. 22 is a cross-sectional view of a guide protrusion of a trigger lever according to the sixth embodiment taken along a left-right direction;

FIG. 23 is a cross-sectional view illustrating a state in which the trigger lever according to a sixth embodiment is pulled;

FIG. 24 is a cross-sectional view illustrating the inside of a first handle part provided with a trigger switch according to a seventh embodiment;

FIG. 25 is a perspective view illustrating the inside of the first handle part provided with the trigger switch according to the seventh embodiment;

FIG. 26 is a cross-sectional view of a first arm of a link mechanism according to the seventh embodiment taken along a front-rear direction;

FIG. 27 is a cross-sectional view of a second arm of the link mechanism according to the seventh embodiment taken along a left-right direction;

FIG. 28 is a cross-sectional view illustrating a state in which a trigger lever according to the seventh embodiment is pulled; and

FIG. 29 is a side view for explaining another method of using the rechargeable earth auger drill.

### DETAILED DESCRIPTION OF THE PREFERRED EMBODIMENTS

In one or more embodiments, a rechargeable angle drill may include: a motor, which includes a rotor configured to rotate about a motor rotation axis, the motor rotation axis extending in an up-down direction; a motor housing part, which houses the motor; a trigger lever, which is operated to start the motor; a handle housing part, which is disposed upward of the motor housing part and in which the trigger lever is provided; a speed reduction mechanism; a gear housing part, which is disposed downward of the motor housing part and houses the speed reduction mechanism; and a rotation output part, which protrudes forward from the gear housing part and rotates about an output rotation axis orthogonal to the motor rotation axis based on a rotational force transmitted from the motor via the speed reduction mechanism. The trigger lever may be disposed upward of a center of the handle housing part in the up-down direction.

According to the above-mentioned configuration, an operator can pull the trigger lever with an index finger. Therefore, operability of the rechargeable angle drill is improved. Therefore, a lateral hole is formed in an excavation target with good operability.

In one or more embodiments, a rechargeable angle drill may include: a motor, which includes a rotor configured to rotate about a motor rotation axis, the motor rotation axis extending in an up-down direction; a motor housing part, which houses the motor; a trigger lever, which is operated to start the motor; a handle housing part, which is disposed upward of the motor housing part and in which the trigger lever is provided; a speed reduction mechanism; a gear housing part, which is disposed downward of the motor housing part and houses the speed reduction mechanism; and a rotation output part, which protrudes forward from the gear housing part and rotates about an output rotation axis orthogonal to the motor rotation axis based on a rotational force transmitted from the motor via the speed reduction mechanism. The trigger lever may be disposed upward of a center of the handle housing part in the up-down direction.

According to the above-mentioned configuration, since the power supply part is disposed upward of the handle housing part, the operability of the rechargeable angle drill when forming the lateral hole in the excavation target is improved.

In one or more embodiments, the rechargeable angle drill may further include a power supply part, which is provided upward of the handle housing part and supplies power to the motor

According to the above-mentioned configuration, since the power supply part is the battery mounting part, the operability of the rechargeable angle drill is improved.

In one or more embodiments, the rechargeable angle drill may further include a battery mounting part, which is provided upward of the handle housing part and to which a battery pack is detachably attached. The power supply part includes the battery mounting part.

According to the above-mentioned configuration, the operator can pull the trigger lever with the index finger with good operability.

In one or more embodiments, the trigger lever may be disposed to protrude forward from a front portion of the first handle part, and the motor may be started by pulling the trigger lever rearward.

According to the above-mentioned configuration, the operator can pull the trigger lever with the index finger with good operability.

In one or more embodiments, the rechargeable angle drill may include a forward/reverse switching lever, which is disposed upward of the trigger lever and operated to change a rotation direction of the motor.

According to the above-mentioned configuration, the operator can operate the forward/reverse switching lever with good operability while gripping the first handle part, for example.

In one or more embodiments, the forward/reverse switching lever may be disposed in the battery holding housing part.

According to the above-mentioned configuration, the operator can operate the forward/reverse switching lever with good operability.

In one or more embodiments, the rechargeable angle drill may include: a motor, which includes a rotor configured to rotate about a motor rotation axis extending in an up-down direction; a motor housing part, which houses the motor; a trigger lever, which is operated to start the motor; a handle housing part, which is disposed upward of the motor housing part and in which the trigger lever is provided; a battery holding housing part, which is provided upward of the handle housing part; a speed reduction mechanism; a gear housing part, which is disposed downward of the motor housing part and houses the speed reduction mechanism; and a rotation output part, which protrudes forward from the gear housing part and rotates about an output rotation axis orthogonal to the motor rotation axis based on a rotational force transmitted from the motor via the speed reduction mechanism. The handle housing part may include: a first handle part, which is connected to each of the motor housing part and the battery holding housing part; and a second handle part, which is disposed forward of the first handle part and connected to each of the motor housing part and the battery holding housing part. The trigger lever may be provided in the first handle part. In the up-down direction, the trigger lever may be operated to pivot about a pivot shaft of the trigger lever defined upward of a center of the handle housing part.

According to the above-mentioned configuration, the operator can pull the trigger lever so that the trigger lever pivots about the pivot shaft defined upward of the center of the handle housing part in the up-down direction. Therefore, operability of the rechargeable angle drill is improved. Therefore, a lateral hole is formed in an excavation target with good operability.

In one or more embodiments, an upper end portion of the trigger lever may be disposed upward of the center of the handle housing part, and a lower end portion of the trigger lever may be disposed downward of the center of the handle housing part. The pivot shaft of the trigger lever may be defined at the upper end portion of the trigger lever.

According to the above-mentioned configuration, the operator can pull the trigger lever with a plurality of fingers. Therefore, operability of the rechargeable angle drill is improved.

In one or more embodiments, the rechargeable angle drill may include a power supply part, which is provided upward of the handle housing part and supplies power to the motor.

According to the above-mentioned configuration, since the power supply part is disposed upward of the handle housing part, the operability of the rechargeable angle drill when forming the lateral hole in the excavation target is improved.

In one or more embodiments, the rechargeable angle drill may include a battery mounting part, which is provided upward of the handle housing part and to which a battery pack is detachably attached. The power supply part may include the battery mounting part.

According to the above-mentioned configuration, since the power supply part is the battery mounting part, the operability of the rechargeable angle drill is improved.

In one or more embodiments, the rechargeable angle drill may include a battery holding housing part in which the battery mounting part is provided. The handle housing part may include a first handle part connected to each of the motor housing part and the battery holding housing part, and a second handle part disposed forward of the first handle part and connected to each of the motor housing part and the battery holding housing part. The trigger lever may be provided in the first handle part.

According to the above-mentioned configuration, the operator can pull the trigger lever with a plurality of fingers with good operability.

In one or more embodiments, the trigger lever may be disposed to protrude forward from a front portion of the first handle part. The motor may be started when the lower end portion of the trigger lever is pulled rearward.

According to the above-mentioned configuration, the operator can pull the trigger lever with a plurality of fingers with good operability.

In one or more embodiments, a rechargeable angle drill may include: a motor, which includes a rotor configured to rotate about a motor rotation axis extending in an up-down direction; a motor housing part, which houses the motor; a first trigger lever, which is operated to start the motor; a handle housing part, which is disposed upward of the motor housing part and in which the first trigger lever is provided; a speed reduction mechanism; a gear housing part, which is disposed downward of the motor housing part and houses the speed reduction mechanism; a rotation output part, which protrudes forward from the gear housing part and rotates about an output rotation axis orthogonal to the motor rotation axis based on a rotational force transmitted from the motor via the speed reduction mechanism; an attachment housing part, which is mounted to the handle housing part; a second trigger lever, which is provided in the attachment housing part; and a coupling mechanism, which is housed in the attachment housing part and couples the second trigger lever and the first trigger lever. The first trigger lever may be operated via the coupling mechanism by operating the second trigger lever.

According to the above-mentioned configuration, the attachment housing part is externally attached to the handle housing part. The operator can pull the first trigger lever provided in the handle housing part by pulling the second trigger lever provided in the attachment housing part. Therefore, operability of the rechargeable angle drill is improved. Therefore, a lateral hole is formed in an excavation target with good operability.

In one or more embodiments, the attachment housing part may include: a connection part, which is connected to the handle housing part; and a grip part, which extends downward from a rear portion of the connection part. The second trigger lever may be disposed upward of a center of the grip part in the up-down direction.

According to the above-mentioned configuration, the operator can pull the second trigger lever with the index finger. Therefore, operability of the rechargeable angle drill is improved.

In one or more embodiments, the first trigger lever may be disposed downward of a center of the handle housing part in the up-down direction.

According to the above-mentioned configuration, the operability of the rechargeable angle drill can be improved without changing the structure of the conventional first trigger lever.

In one or more embodiments, the rechargeable angle drill may include: a battery mounting part, which is provided upward of the handle housing part and to which a battery pack is detachably attached; and a battery holding housing part in which the battery mounting part is provided. The handle housing part may include: a first handle part, which is connected to each of the motor housing part and the battery holding housing part; and a second handle part, which is disposed forward of the first handle part and connected to each of the motor housing part and the battery holding housing part. The connection part may include: a first connection part, which is disposed rearward of the first handle part; and a second connection part, which is disposed between the first handle part and the second handle part. The grip part may be provided to extend downward from the first connection part. The second trigger lever may be disposed to protrude forward from a front portion of the grip part. The first trigger lever may be operated by pulling the second trigger lever rearward.

According to the above-mentioned configuration, the operator can pull the second trigger lever provided in the attachment housing part with good operability.

In one or more embodiments, the attachment housing part may include: a first attachment housing part; a second attachment housing part, which is disposed on the right side of the first attachment housing part and sandwiches the handle housing part with the first attachment housing part; and a plurality of screws, which fix the first attachment housing part and the second attachment housing part.

According to the above-mentioned configuration, since the attachment housing part has a so-called half housing structure, the attachment housing part is smoothly mounted on the handle housing part.

In one or more embodiments, the rechargeable angle drill may include a spherical side handle fixed to the gear housing part.

According to the above-mentioned configuration, the operator can easily grip the side handle.

In one or more embodiments, the rechargeable angle drill may include a belt having one end portion coupled to the handle housing part and the other end portion coupled to the gear housing part or a rear handle provided on the gear housing part.

According to the above-mentioned configuration, the operator can support the rechargeable angle drill with the shoulder via the belt by hooking the belt on the shoulder. The operator can receive the weight of the rechargeable angle drill at the shoulder or the torque acting on the rechargeable angle drill.

In one or more embodiments, a rechargeable earth auger drill may include: a motor, which includes a rotor configured to rotate about a motor rotation axis; a motor housing part, which houses the motor; a trigger switch, which includes a trigger lever to be operated to start the motor; a handle housing part, which is disposed on a first side with respect to the motor housing part in a direction of the motor rotation axis and includes a handle part in which the trigger switch is provided; a speed reduction mechanism; a gear housing part, which is disposed on a second side with respect to the motor housing part in the direction of the motor rotation axis and houses the speed reduction mechanism; and a rotation output part, which protrudes from the gear housing part and rotates about an output rotation axis orthogonal to the motor rotation axis based on a rotational force transmitted from the motor via the speed reduction mechanism. The trigger lever may include a pressing surface formed over a first end portion side and a second end portion side of the handle part across a center of the handle part in the direction of the motor rotation axis. The trigger switch may be configured such that magnitude of an operating force for operating the trigger lever is brought close to each other between a position of the pressing surface on the first end portion side from the center of the handle part and a position of the pressing surface on the second end portion side from the center.

According to the above-mentioned configuration, the difference in the operating force for operating the trigger lever is reduced between a case where the position of the pressing surface on the first end portion side from the center of the handle part is pulled and a case where the position of the pressing surface on the second end portion side from the center of the handle part is pulled. Therefore, even when the direction of the hand of the operator holding the handle part is changed between the case where the rechargeable earth auger drill is used in a vertical placement state to form the lateral hole and the case where the rechargeable earth auger drill is used in a horizontal placement state to form a vertical hole, and the position at which the pulling operation of the trigger lever is performed is changed, the difference in the operating force required for the pulling operation is reduced. Therefore, the operability of the rechargeable earth auger drill can be improved.

In one or more embodiments, the trigger switch may include: a switch circuit, which outputs an operation signal in response to an operation of the trigger lever; and a link mechanism, which supports the trigger lever to be movable according to an action of the operating force applied on the pressing surface.

According to the above-mentioned configuration, it is possible to easily realize a structure in which the trigger lever is moved evenly between the case where the position of the pressing surface on the first end portion side is operated and the case where the position thereof on the second end portion side is operated by the link mechanism. Therefore, it is possible to effectively reduce the difference in the operating force required for the pulling operation on different positions of the pressing surface.

In one or more embodiments, the link mechanism may support the trigger lever at a first support position on the first end portion side from the center of the handle part and at a second support position on the second end portion side from the center.

According to the above-mentioned configuration, it is possible to equalize the operating force required when the position of the pressing surface on the first end portion side from the center of the handle part is pulled and the operating force required when the position of the pressing surface on the second end portion side from the center is pulled.

In one or more embodiments, the switch circuit may be disposed between the first support position on the first end portion side and the second support position on the second end portion side. The link mechanism may include an arm foldable by a plurality of links connected by a hinge shaft. The hinge shaft may be configured to move in a direction approaching a center of the trigger lever with a folding operation of the arm.

According to the above-mentioned configuration, since the switch circuit and the link mechanism are prevented from protruding outside the trigger lever, the trigger switch can be downsized even when the trigger switch including the link mechanism is provided.

Hereinafter, embodiments according to the present disclosure will be described with reference to the drawings, but the present disclosure is not limited to the embodiments. The components of the embodiments described below can be appropriately combined. In addition, some components may not be used.

In the embodiment, the positional relationship of each part will be described using terms of “left”, “right”, “front”, “rear”, “up”, and “down”. These terms refer to directions during work with rechargeable angle drills. For example, in a case where the rechargeable angle drill is sold in a tool shop or in a case where the rechargeable angle drill is listed in a sales catalog, it is assumed that the up-down direction is reversed.

### First Embodiment

### Rechargeable Angle Drill

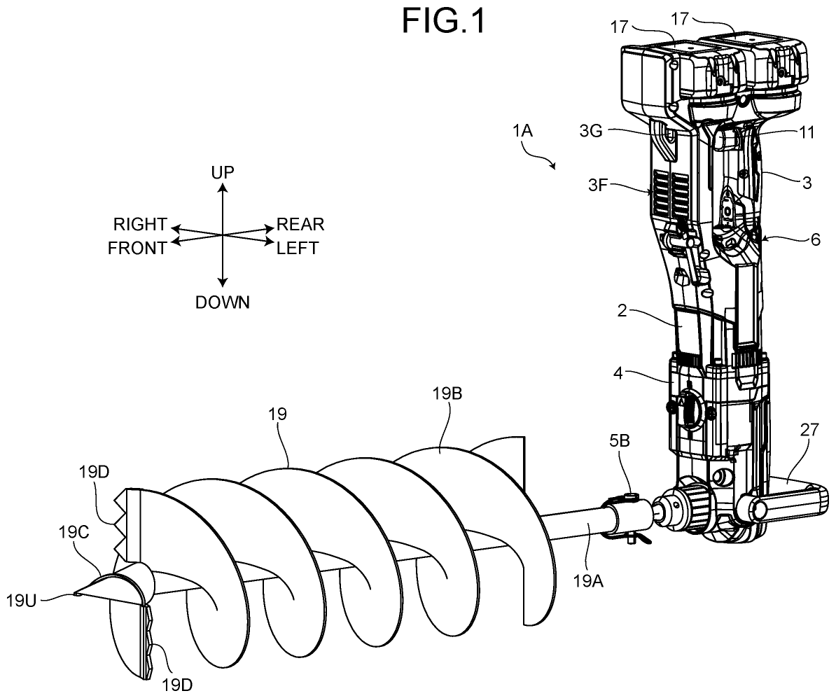

FIG. 1 is a front perspective view illustrating a rechargeable angle drill 1A according to the present embodiment.

The rechargeable angle drill 1A is a portable rechargeable angle drill that excavates an excavation target while being held by an operator and forms a hole in the excavation target. The target to be excavated by the rechargeable angle drill 1A is not particularly limited, and the rechargeable angle drill 1A can perform drilling of a ceiling, a wall surface, and the like of a structure and drilling of a ground by replacing a detachable drill bit 19. That is, the rechargeable angle drill 1A can also be referred to as a rechargeable earth auger drill that excavates the ground. In the present embodiment, the excavation target is the ground. The rechargeable angle drill 1A is used to form a lateral hole in the ground.

The rechargeable angle drill 1A includes a main body 6 and the drill bit 19.

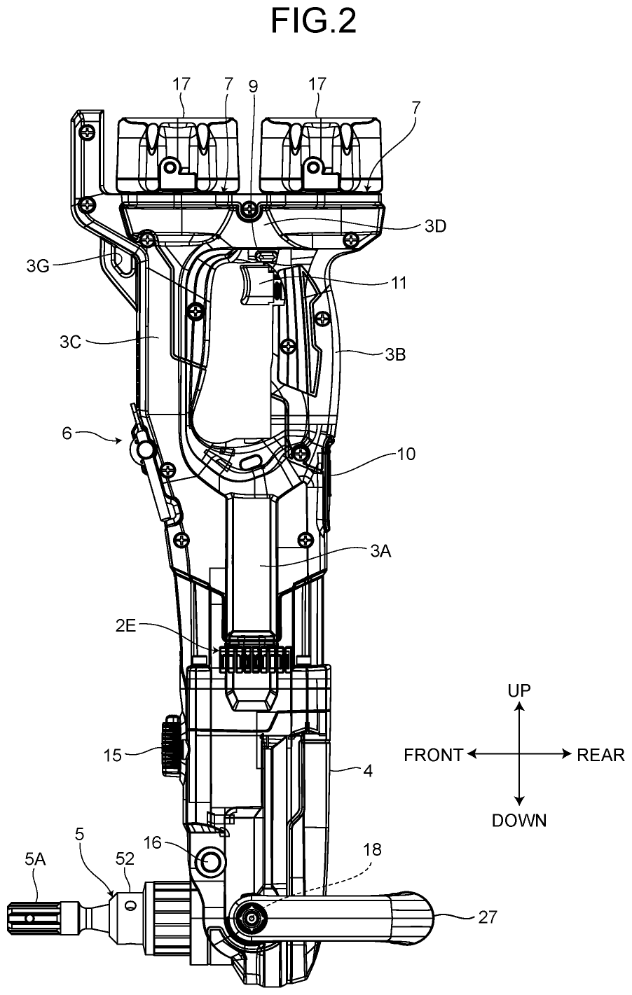

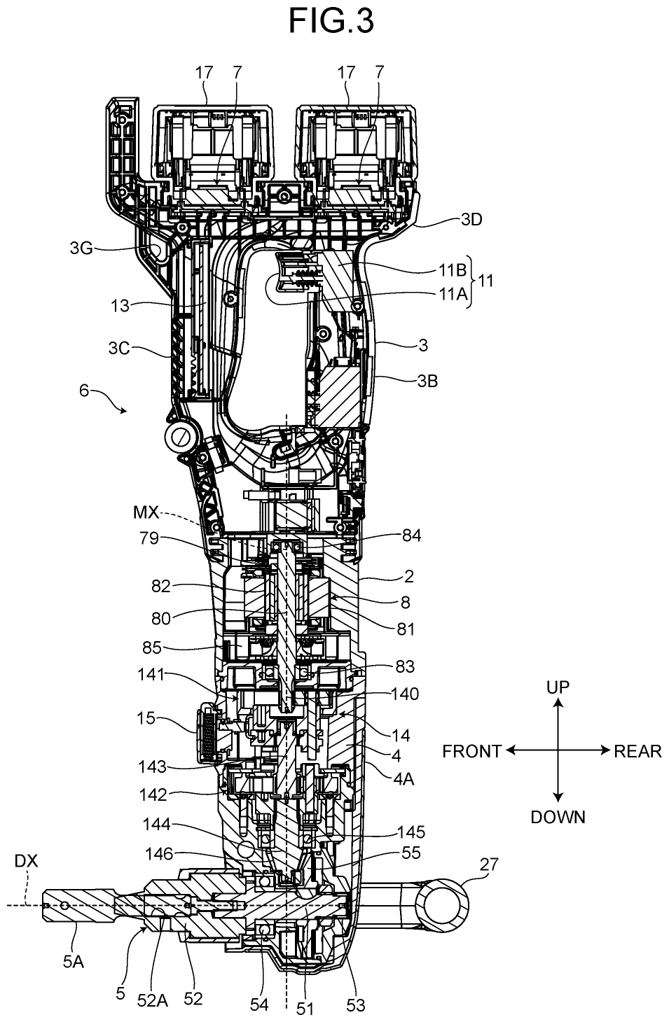

FIG. 2 is a side view illustrating the main body 6 of the rechargeable angle drill 1A according to the present embodiment. FIG. 3 is a cross-sectional view illustrating the main body 6 of the rechargeable angle drill 1A according to the present embodiment.

As illustrated in FIGS. 1, 2, and 3, the main body 6 includes a motor housing part 2, a handle housing part 3, a gear housing part 4, a battery mounting part 7, a controller 13, a main switch 10, a trigger switch 11, a forward/reverse switching lever 9, a speed switching lever 15, a motor 8, a speed reduction mechanism 14, and a rotation output part 5.

The motor housing part 2 houses the motor 8. The motor housing part 2 has a tubular shape elongated in the up-down direction. The motor housing part 2 is made of synthetic resin. The motor housing part 2 has an exhaust port 2E that connects an internal space and an external space of the motor housing part 2. The exhaust port 2E is provided in each of the left portion, the right portion, and the front portion of the motor housing part 2. The air in the internal space of the motor housing part 2 is discharged to the external space via the exhaust ports 2E.

The handle housing part 3 is disposed upward of the motor housing part 2. A lower portion of the handle housing part 3 is connected to an upper portion of the motor housing part 2. The handle housing part 3 has a loop shape elongated in the up-down direction. The handle housing part 3 is made of synthetic resin.

The handle housing part 3 includes an under part 3A connected to the upper portion of the motor housing part 2, a first handle part 3B extending upward from a rear portion of the under part 3A, a second handle part 3C extending upward from a front portion of the under part 3A, and a battery holding housing part 3D connecting an upper end portion of the first handle part 3B and an upper end portion of the second handle part 3C. The first handle part 3B is connected to each of the motor housing part 2 and the battery holding housing part 3D. The second handle part 3C is connected to each of the motor housing part 2 and the battery holding housing part 3D. The first handle part 3B and the second handle part 3C are connected to the motor housing part 2 via the under part 3A. The second handle part 3C is disposed forward of the first handle part 3B. The first handle part 3B and the second handle part 3C are disposed upward of the motor housing part 2. The operator can hold the first handle part 3B by his/her hand. An intake port 3F is provided in a front portion of the second handle part 3C.

The gear housing part 4 houses the speed reduction mechanism 14. The gear housing part 4 has a tubular shape elongated in the up-down direction. The gear housing part 4 is disposed downward of the motor housing part 2. The upper portion of the gear housing part 4 is connected to the lower portion of the motor housing part 2. The gear housing part 4 is made of aluminum. At least a part of the surface of the gear housing part 4 is covered with a cover 4A. In the present embodiment, the cover 4A has a two-layer structure of synthetic resin and elastomer.

A screw hole 16 is provided in each of the left portion and the right portion of the gear housing part 4. A screw hole 18 is provided in each of the left portion and the right portion of the gear housing part 4. The screw holes 18 are provided behind and below the screw holes 16. In the up-down direction, the position of the screw holes 18 and the position of the rotation output part 5 are substantially equal.

The battery mounting part 7 is provided upward of the handle housing part 3. The battery mounting part 7 is provided in the battery holding housing part 3D. The battery pack 17 is mounted on the battery mounting part 7. The battery mounting part 7 functions as a power supply part that supplies power to the motor 8.

In the present embodiment, two battery mounting parts 7 are provided in the front-rear direction. As the battery pack 17 is mounted to each of the two battery mounting parts 7, two battery packs 17 are arranged in the front-rear direction. The battery pack 17 is detachable from the battery mounting part 7. By being mounted to the battery mounting part 7, the battery pack 17 can supply power to the rechargeable angle drill 1A. The battery pack 17 includes a secondary battery. In the present embodiment, the battery pack 17 includes a rechargeable lithium ion battery.

The controller 13 outputs control signals for controlling the rechargeable angle drill 1A. The second handle part 3C has an internal space capable of housing the controller 13. The controller 13 is housed in the second handle part 3C.

The main switch 10 is operated by an operator to activate the rechargeable angle drill 1A. The main switch 10 is provided at the rear portion of the under part 3A. When the main switch 10 is operated, power is supplied from the battery pack 17 to the controller 13, and the rechargeable angle drill 1A is activated. The main switch 10 is operated to change between driving and stopping of the rechargeable angle drill 1A.

The trigger switch 11 is operated by an operator to start the motor 8. The trigger switch 11 is provided on the handle housing part 3. The trigger switch 11 includes a trigger lever 11A and a switch circuit 11B. The trigger lever 11A is operated by an operator to start the motor 8.

In the present embodiment, the trigger switch 11 including the trigger lever 11A and the switch circuit 11B is provided on the first handle part 3B. The trigger lever 11A is disposed to protrude forward from the front portion of the first handle part 3B. In a state where the operator grips the first handle part 3B with one of the left and right hands, the operator can pull the trigger lever 11A rearward with the finger so that the trigger lever 11A moves rearward. When the trigger lever 11A is pulled rearward, the motor 8 is started. The trigger lever 11A is biased forward by a biasing member. When the pulling operation of the trigger lever 11A is released, the trigger lever 11A moves forward and the motor 8 stops.

The first handle part 3B has an internal space capable of housing the switch circuit 11B. The switch circuit 11B is housed in the first handle part 3B. The switch circuit 11B outputs operation signals when the trigger lever 11A is pulled. By pulling the trigger lever 11A rearward in a state where the rechargeable angle drill 1A is activated, electric power is supplied from the battery pack 17 to the motor 8, and the motor 8 is started. The motor 8 is driven based on operation signals output from the switch circuit 11B. When the operation and the operation release of the trigger lever 11A are switched, the driving and the stopping of the motor 8 are switched.

An upper end portion 3P of the first handle part 3B is connected to the battery holding housing part 3D. A lower end portion 3Q of the first handle part 3B is connected to the under part 3A. In the up-down direction, the trigger lever 11A is disposed upward of the center 3R of the handle housing part 3. In the present embodiment, the trigger lever 11A is disposed to protrude forward from the front portion of the upper portion of the first handle part 3B in the up-down direction. Similarly to the trigger lever 11A, the switch circuit 11B is disposed upward of the center 3R of the first handle part 3B in the up-down direction.

The forward/reverse switching lever 9 is operated by an operator to change the rotation direction of the motor 8. When the forward/reverse switching lever 9 is operated in the left-right direction, the rotation direction of the motor 8 is changed between the forward rotation direction and the reverse rotation direction. When the rotation direction of the motor 8 is changed, the rotation direction of the rotation output part 5 is changed between the forward rotation direction and the reverse rotation direction.

In the present embodiment, the forward/reverse switching lever 9 is disposed upward of the trigger lever 11A. The forward/reverse switching lever 9 is disposed on the battery holding housing part 3D.

The speed switching lever 15 is operated by an operator to change the rotation speed of the rotation output part 5. The speed switching lever 15 is provided at the front portion of the gear housing part 4. When the speed switching lever 15 is operated in the up-down direction, the rotation speed of the rotation output part 5 is changed between a first speed and a second speed higher than the first speed.

The motor 8 generates a rotational force for rotating the rotation output part 5. The motor 8 is driven based on electric power supplied from the battery pack 17. The motor 8 is an inner rotor type brushless motor. The motor 8 includes a tubular stator 81, a rotor 82 disposed inside the stator 81, and a rotor shaft 80 fixed to the rotor 82. A motor rotation axis MX indicating the rotation shaft of the rotor 82 extends in the up-down direction. The rotor 82 rotates about a motor rotation axis MX extending in the up-down direction.

The stator 81 includes a stator core including a plurality of stacked steel plates, an insulator fixed to the stator core, and a plurality of coils wound around the stator core via the insulator.

The rotor 82 includes a tubular rotor core disposed around the rotor shaft 80 and a plurality of permanent magnets held by the rotor core. A lower portion of the rotor shaft 80 is rotatably supported by a bearing 83. An upper portion of the rotor shaft 80 is rotatably supported by a bearing 84.

A sensor circuit board 79 is disposed above the stator 81. The rotation of the rotor 82 is detected by a rotation detection element provided on the sensor circuit board 79. The controller 13 controls the drive current supplied to the motor 8 based on the detection signal of the rotation detection element.

A centrifugal fan 85 is attached to the rotor shaft 80 between the bearing 83 and the stator 81. The exhaust port 2E of the motor housing part 2 is disposed in a part of the periphery of the centrifugal fan 85. When the rotor shaft 80 rotates and the centrifugal fan 85 rotates, the air around the rechargeable angle drill 1A flows into the internal space of the handle housing part 3 and the internal space of the motor housing part 2 via the intake port 3F. The air flowing into the internal space of the handle housing part 3 and the internal space of the motor housing part 2 cools the controller 13 and the motor 8, and then is discharged to the external space of the motor housing part 2 via the exhaust port 2E.

A pinion gear 140 is provided at the lower end portion of the rotor shaft 80. The pinion gear 140 is arranged in the internal space of the gear housing part 4. The rotor shaft 80 is coupled to the speed reduction mechanism 14 via the pinion gear 140.

The speed reduction mechanism 14 transmits the rotational force generated by the motor 8 to the rotation output part 5. The speed reduction mechanism 14 transmits the rotational force from the rotor shaft 80 to the rotation output part 5. The speed reduction mechanism 14 includes a plurality of gears. The speed reduction mechanism 14 includes a first planetary gear mechanism 141, a second planetary gear mechanism 142, an intermediate shaft 143, and an output shaft 144. The rotation axis of the rotor shaft 80, the rotation axis of the intermediate shaft 143, and the rotation axis of the output shaft 144 coincide with each other.

The first planetary gear mechanism 141 is disposed below the rotor shaft 80. The intermediate shaft 143 is disposed below the first planetary gear mechanism 141. The second planetary gear mechanism 142 is disposed below the intermediate shaft 143. The output shaft 144 is disposed below the second planetary gear mechanism 142.

The pinion gear 140 provided at the lower end portion of the rotor shaft 80 functions as a sun gear of the first planetary gear mechanism 141. The second planetary gear mechanism 142 is disposed below the first planetary gear mechanism 141. The first planetary gear mechanism 141 is coupled to the second planetary gear mechanism 142 via the intermediate shaft 143. The sun gear of the second planetary gear mechanism 142 is provided at the lower end portion of the intermediate shaft 143. The rotation decelerated by the first planetary gear mechanism 141 is further decelerated by the second planetary gear mechanism 142. The rotation of the second planetary gear mechanism 142 rotates the output shaft 144.

The output shaft 144 is rotatably supported by the bearing 145. A bevel gear 146 is provided at the lower end portion of the output shaft 144. The lower end portion of the output shaft 144 is coupled to the rotation output part 5 via the bevel gear 146.

The rotation output part 5 rotates based on the rotational force transmitted from the motor 8 via the speed reduction mechanism 14. The rotation output part 5 protrudes forward from the lower portion of the gear housing part 4. The drill bit 19 is attached to the rotation output part 5. The rotation output part 5 is rotatable with the drill bit 19 attached thereto. An output rotation axis DX indicating the rotation axis of the rotation output part 5 extends in the front-rear direction. The rotation output part 5 rotates about the output rotation axis DX. The motor rotation axis MX of the rotor 82 and the output rotation axis DX of the rotation output part 5 are orthogonal to each other.

The rotation output part 5 includes a spindle 51 and a drill chuck 52 mounted on the front end portion of the spindle 51. The drill chuck 52 has an insertion hole 52A into which the drill bit 19 is inserted. The insertion hole 52A is formed to extend rearward from the front end portion of the drill chuck 52. The drill chuck 52 is rotatable with the drill bit 19 attached thereto.

The spindle 51 is rotatably supported by each of a needle bearing 53 and a ball bearing 54. The rear end portion of the spindle 51 is rotatably supported by the needle bearing 53. The front portion of the spindle 51 is rotatably supported by the ball bearing 54.

A bevel gear 55 is provided at the rear of the spindle 51. The bevel gear 55 meshes with the bevel gear 146 of the output shaft 144.

The drill bit 19 is attached to the rotation output part 5. The drill bit 19 is a drill bit for excavation called an earth auger drill bit. As illustrated in FIG. 1, the drill bit 19 includes an excavation shaft 19A, an excavation double spiral blade 19B, a tip bit 19C, and two cutting blades 19D.

The excavation shaft 19A extends in the front-rear direction. When the drill bit 19 is attached to the rotation output part 5, an adapter 5A is inserted into the insertion hole 52A of the drill chuck 52. The adapter 5A is a rod-shaped member. A hole into which the adapter 5A is inserted is provided at the rear end portion of the excavation shaft 19A. The rear end portion of the excavation shaft 19A and the adapter 5A are fixed by the fixture 5B in a state where the adapter 5A is inserted into the hole at the rear end portion of the excavation shaft 19A. A rear end portion of the excavation shaft 19A is attached to the drill chuck 52 via the adapter 5A.

The excavation double spiral blade 19B is arranged in a double spiral shape around the excavation shaft 19A. The excavation double spiral blade 19B is fixed to the excavation shaft 19A. The tip bit 19C is disposed at the front end portion of the excavation shaft 19A. Each of the two cutting blades 19D is disposed at the front end portion of the excavation double spiral blade 19B.

A rear handle 27 is fixed to the gear housing part 4. At least a part of the rear handle 27 protrudes rearward from the gear housing part 4. The rear handle 27 is fixed to the gear housing part 4 by screws. Screw for fixing the rear handle 27 to the gear housing part 4 are inserted into the screw holes 18.

### Usage Method

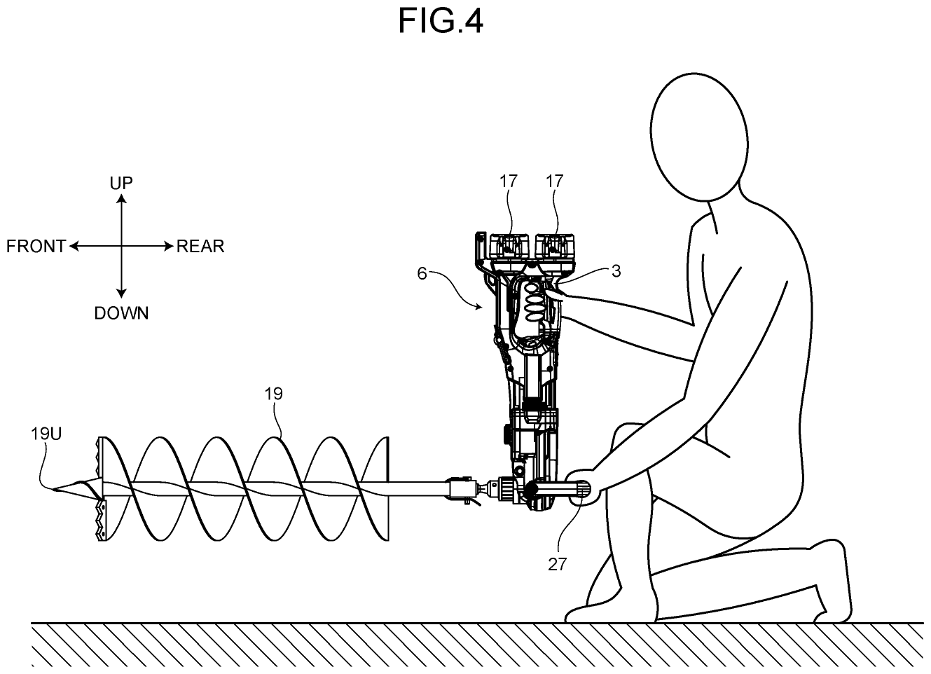

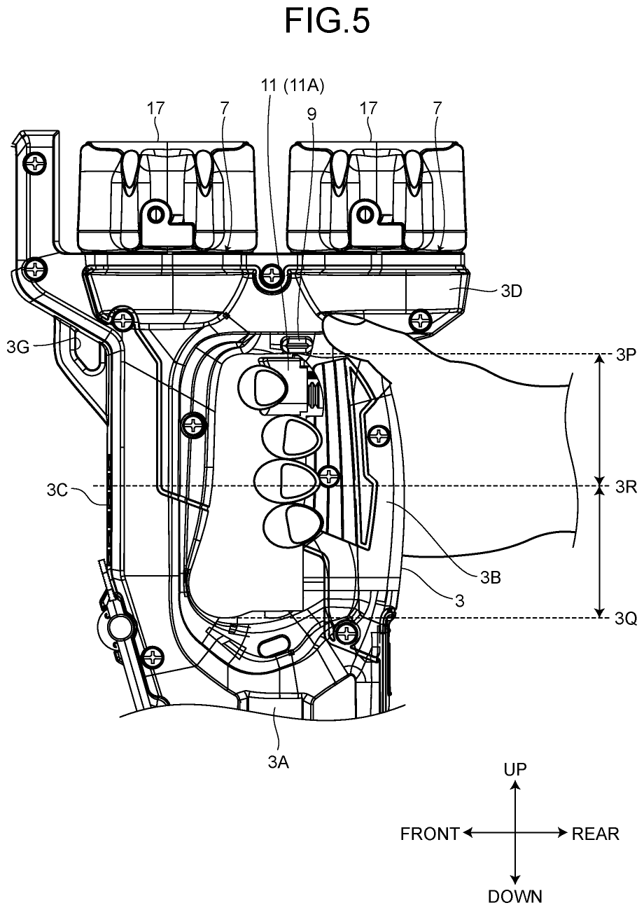

Next, a method of using the rechargeable angle drill 1A according to the present embodiment will be described. FIG. 4 is a side view for explaining the method of using the rechargeable angle drill 1A according to the present embodiment. FIG. 5 is a side view illustrating the vicinity of the trigger lever 11A according to the present embodiment.

The rechargeable angle drill 1A is used to form a lateral hole in an excavation target. The rechargeable angle drill 1A is used with the motor housing part 2 disposed upward of the gear housing part 4. That is, the rechargeable angle drill 1A is used in a vertical placement state. The operator holds the rechargeable angle drill 1A such that the motor housing part 2 is disposed upward of the gear housing part 4. In the example illustrated in FIGS. 4 and 5, the operator grips the first handle part 3B with the right hand and grips the rear handle 27 with the left hand.

The operator pulls the trigger lever 11A with the index finger of the right hand gripping the first handle part 3B. When the trigger lever 11A is pulled, the rotation output part 5 rotates with the drill bit 19 attached.

The operator presses a front end portion 19U of the rotating drill bit 19 against the excavation target existing in front of the rechargeable angle drill 1A. When the rotating drill bit 19 is pressed against the excavation target, the excavation target is excavated, and a lateral hole is formed in the excavation target. The operator pushes the rechargeable angle drill 1A forward while the drill bit 19 is rotating. When removing the excavated object from the lateral hole formed in the excavation target, the operator pulls out the rechargeable angle drill 1A rearward.

The operator can operate the forward/reverse switching lever 9 with a finger (for example, a thumb) of the right hand while gripping the first handle part 3B with the right hand, for example.

The operator may grip the first handle part 3B with the left hand and grip the rear handle 27 with the right hand. The operator pulls the trigger lever 11A with the index finger of the left hand gripping the first handle part 3B.

### Effects

As described above, in the present embodiment, the rechargeable angle drill 1A may include: the motor 8, which includes the rotor 82 configured to rotate about the motor rotation axis MX extending in the up-down direction; the motor housing part 2, which houses the motor 8; the trigger lever 11A, which is operated to start the motor 8; the handle housing part 3, which is disposed upward of the motor housing part 2 and in which the trigger lever 11A is provided; the speed reduction mechanism 14; the gear housing part 4, which is disposed downward of the motor housing part 2 and houses the speed reduction mechanism 14; and the rotation output part 5, which protrudes forward from the gear housing part and rotates about the output rotation axis DX orthogonal to the motor rotation axis MX based on the rotational force transmitted from the motor 8 via the speed reduction mechanism 14. In the up-down direction, the trigger lever 11A may be disposed upward of the center of the handle housing part 3.

According to the above-mentioned configuration, the operator can pull the trigger lever 11A with the index finger. Therefore, the operability of the rechargeable angle drill 1A is improved. Therefore, a lateral hole is formed in an excavation target with good operability.

In the present embodiment, the rechargeable angle drill 1A may include the power supply part, which is provided upward of the handle housing part 3 and supply power to the motor 8.

According to the above-mentioned configuration, since the power supply part is disposed upward of the handle housing part 3, the operability of the rechargeable angle drill 1A when forming the lateral hole in the excavation target is improved.

In the present embodiment, the rechargeable angle drill 1A may include the battery mounting part 7, which is provided upward of the handle housing part 3 and to which the battery pack 17 is detachably attached. The power supply part may include the battery mounting part 7.

According to the above-mentioned configuration, since the power supply part is the battery mounting part 7, the operability of the rechargeable angle drill 1A is improved.

In the present embodiment, the handle housing part 3 may have the battery holding housing part 3D in which the battery mounting part 7 is provided. The handle housing part 3 may include the first handle part 3B, which is connected to each of the motor housing part 2 and the battery holding housing part 3D, and the second handle part 3C, which is disposed forward of the first handle part 3B and connected to each of the motor housing part 2 and the battery holding housing part 3D. The trigger lever 11A may be provided on the first handle part 3B.

According to the above-mentioned configuration, the operator can pull the trigger lever 11A with the index finger with good operability.

In the present embodiment, the trigger lever 11A may be disposed to protrude forward from the front portion of the first handle part 3B, and the motor 8 is started by pulling the trigger lever 11A rearward.

According to the above-mentioned configuration, the operator can pull the trigger lever 11A with the index finger with good operability.

In the present embodiment, the rechargeable angle drill 1A may include the forward/reverse switching lever 9, which is disposed upward of the trigger lever 11A and operated to change the rotation direction of the motor 8.

According to the above-mentioned configuration, the operator can operate the forward/reverse switching lever 9 with good operability while gripping the first handle part 3B, for example.

In the present embodiment, the forward/reverse switching lever 9 may be disposed on the battery holding housing part 3D.

According to the above-mentioned configuration, the operator can operate the forward/reverse switching lever 9 with good operability.

### Second Embodiment

A second embodiment will be described. In the following description, the same or equivalent components as those of the above-described embodiments are denoted by the same reference numerals, and the description of the components is simplified or omitted.

### Rechargeable Angle Drill

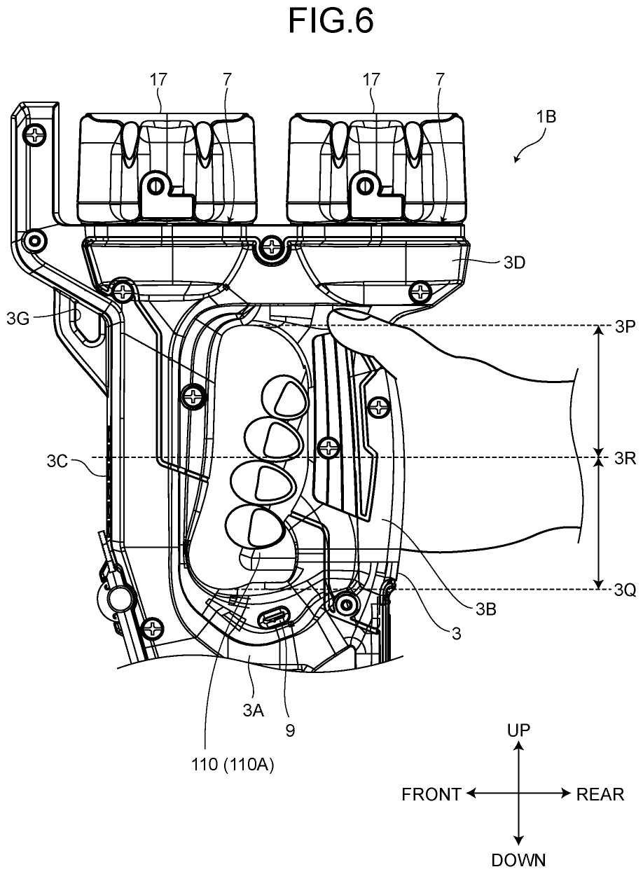

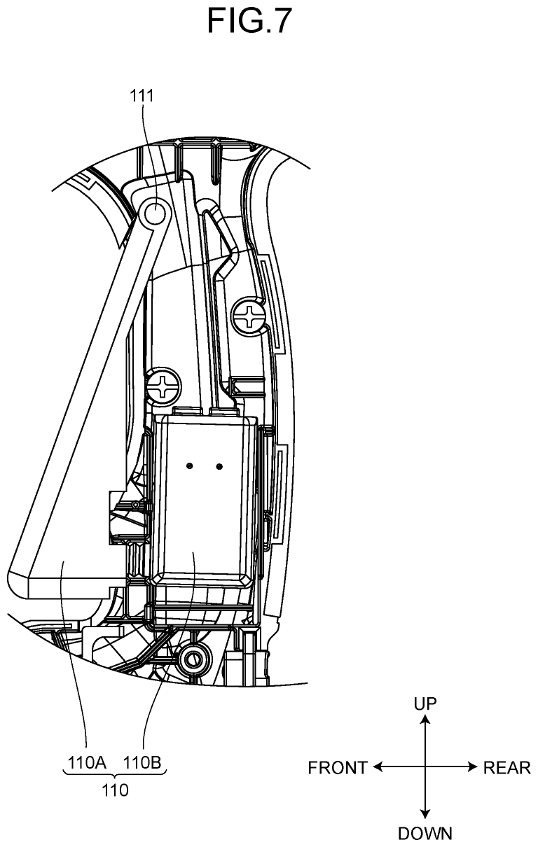

FIG. 6 is a side view illustrating the vicinity of a trigger lever 110A of a rechargeable angle drill 1B according to the present embodiment. FIG. 7 is a view illustrating the inside of a first handle part 3B provided with a trigger switch 110 according to the present embodiment. The rechargeable angle drill 1B according to the present embodiment can also be referred to as a rechargeable earth auger drill.

The trigger switch 110 is operated by an operator to start the motor 8. The trigger switch 110 is provided in the handle housing part 3. The trigger switch 110 includes a trigger lever 110A and a switch circuit 110B. The trigger lever 110A is operated by an operator to start the motor 8.

The trigger switch 110 including the trigger lever 110A and the switch circuit 110B is provided in the first handle part 3B. The trigger lever 110A is disposed to protrude forward from the front portion of the first handle part 3B. In a state where the operator grips the first handle part 3B with one of the left and right hands, the operator can pull the trigger lever 110A rearward with the finger so that the trigger lever 110A moves rearward. By pulling the trigger lever 110A rearward, the motor 8 is started.

The first handle part 3B has an internal space capable of housing the switch circuit 110B. The trigger lever 110A is disposed to protrude forward from the front portion of the first handle part 3B. The switch circuit 110B is housed in the first handle part 3B. The switch circuit 110B outputs operation signals when the trigger lever 110A is pulled. When the trigger lever 110A is pulled rearward in a state where the rechargeable angle drill 1B is activated, electric power is supplied from the battery pack 17 to the motor 8, and the motor 8 is started. The motor 8 is driven based on operation signals output from the switch circuit 110B. When the operation and the operation release of the trigger lever 110A are switched, the driving and the stopping of the motor 8 are switched.

In the up-down direction, the trigger lever 110A is operated to pivot about a pivot shaft 111 of the trigger lever 110A defined upward of the center 3R of the first handle part 3B. The pivot shaft 111 extends in the left-right direction. The trigger lever 110A is a so-called paddle switch. When the trigger lever 110A is pulled, the trigger lever 110A pivots about the pivot shaft 111 such that the lower end portion of the trigger lever 110A moves rearward.

In the up-down direction, the upper end portion of the trigger lever 110A is disposed upward of the center 3R of the first handle part 3B. The lower end portion of the trigger lever 110A is disposed downward of the center 3R of the first handle part 3B. The pivot shaft 111 of the trigger lever 110A is defined at the upper end portion of the trigger lever 110A.

The switch circuit 110B is disposed downward of the center 3R of the first handle part 3B in the up-down direction.

In the present embodiment, the forward/reverse switching lever 9 is disposed downward of the trigger lever 110A. The forward/reverse switching lever 9 is disposed in the under part 3A.

### Effects

As described above, in the present embodiment, the rechargeable angle drill 1B may include: the motor 8, which include the rotor 82 configured to rotate about the motor rotation axis MX extending in the up-down direction; the motor housing part 2, which houses the motor 8; the trigger lever 110A, which is operated to start the motor 8; the handle housing part 3, which is disposed upward of the motor housing part 2 and in which the trigger lever 110A is provided; the speed reduction mechanism 14; the gear housing part 4, which is disposed downward of the motor housing part 2 and houses the speed reduction mechanism 14; and the rotation output part 5, which protrudes forward from the gear housing part 4 and rotates about the output rotation axis DX orthogonal to the motor rotation axis MX based on the rotational force transmitted from the motor 8 via the speed reduction mechanism 14. In the up-down direction, the trigger lever 110A may be operated to pivot about a pivot shaft 111 of the trigger lever 110A defined upward of the center 3R of the handle housing part 3.

According to the above-mentioned configuration, the operator can pull the trigger lever 110A so that the trigger lever 110A pivots about the pivot shaft 111 defined upward of the center 3R of the handle housing part 3 in the up-down direction. Therefore, the operability of the rechargeable angle drill 1B is improved. Therefore, a lateral hole is formed in an excavation target with good operability.

In the present embodiment, the upper end portion of the trigger lever 110A may be disposed upward of the center 3R of the handle housing part 3, and the lower end portion of the trigger lever 110A may be disposed downward of the center 3R of the handle housing part 3. The pivot shaft 111 of the trigger lever 110A may be defined at the upper end portion of the trigger lever 110A.

According to the above-mentioned configuration, the operator can pull the trigger lever 110A with a plurality of fingers. Therefore, the operability of the rechargeable angle drill 1B is improved.

In the present embodiment, the rechargeable angle drill 1B may include the power supply part, which is provided upward of the handle housing part 3 and supplies power to the motor 8.

According to the above-mentioned configuration, since the power supply part is disposed upward of the handle housing part 3, the operability of the rechargeable angle drill 1B when forming the lateral hole in the excavation target is improved.

In the present embodiment, the rechargeable angle drill 1B may include the battery mounting part 7, which is provided upward of the handle housing part 3 and to which the battery pack 17 is detachably attached. The power supply part may include the battery mounting part 7.

According to the above-mentioned configuration, since the power supply part is the battery mounting part 7, the operability of the rechargeable angle drill 1B is improved.

In the present embodiment, the handle housing part 3 may have the battery holding housing part 3D in which the battery mounting part 7 is provided. The handle housing part 3 may include the first handle part 3B connected to each of the motor housing part 2 and the battery holding housing part, and the second handle part 3C disposed forward of the first handle part 3B and connected to each of the motor housing part 2 and the battery holding housing part 3D. The trigger lever 110A may be provided on the first handle part 3B.

According to the above-mentioned, the operator can pull the trigger lever 110A with a plurality of fingers with good operability.

In the present embodiment, the trigger lever 110A may be disposed to protrude forward from the front portion of the first handle part 3B, and the motor 8 may be started by pulling the lower end portion of the trigger lever 110A rearward.

According to the above-mentioned configuration, the operator can pull the trigger lever 110A with a plurality of fingers with good operability.

### Third Embodiment

A third embodiment will be described. In the following description, the same or equivalent components as those of the above-described embodiments are denoted by the same reference numerals, and the description of the components is simplified or omitted.

### Rechargeable Angle Drill

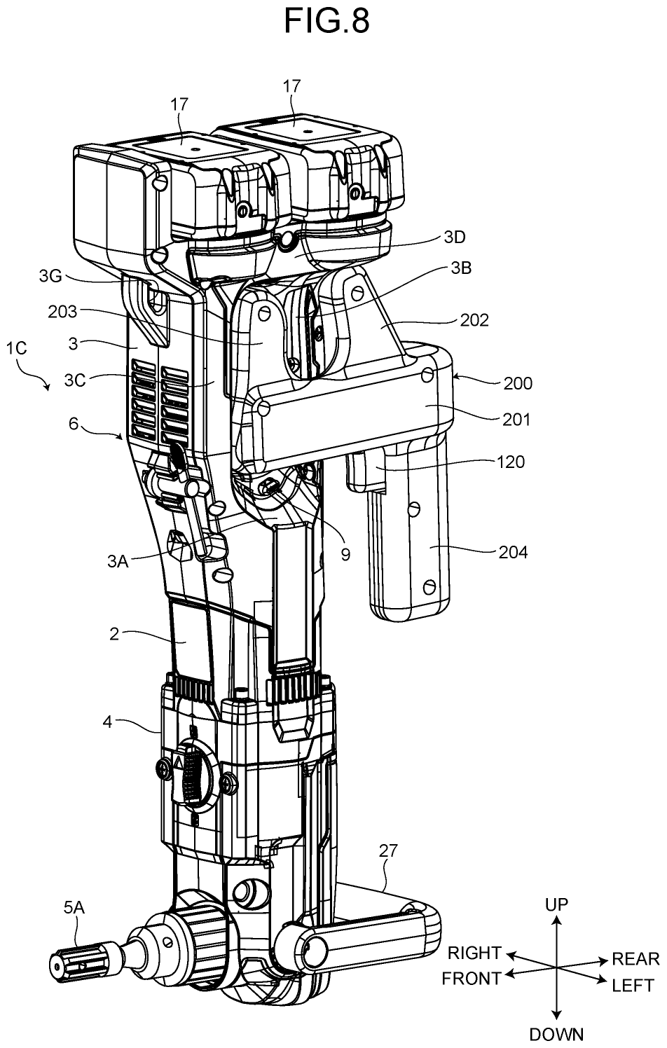

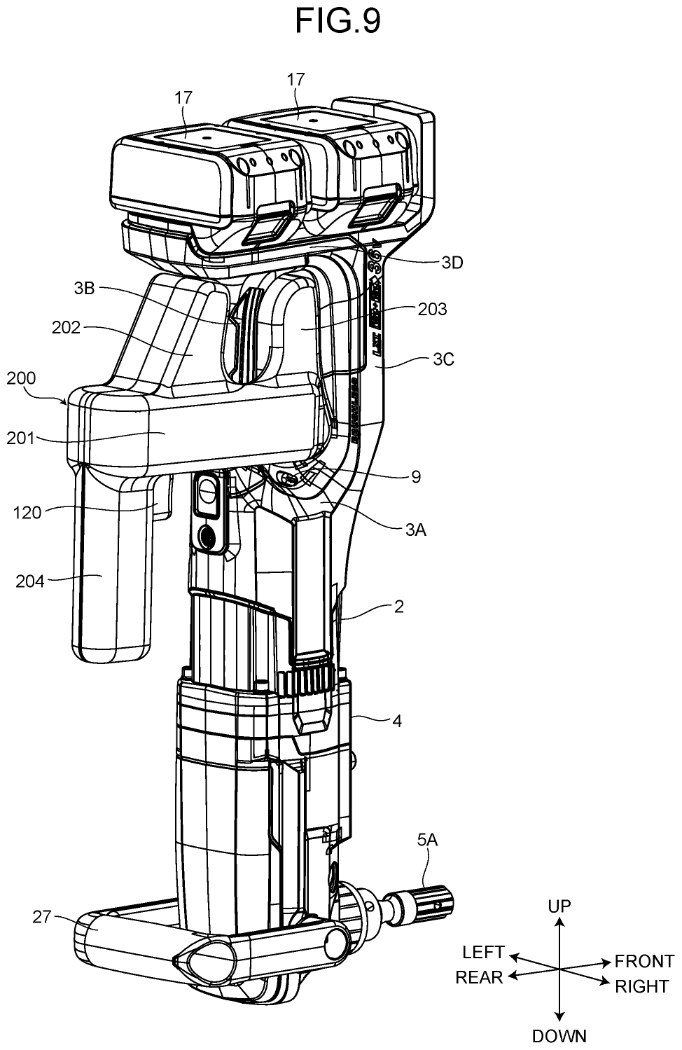

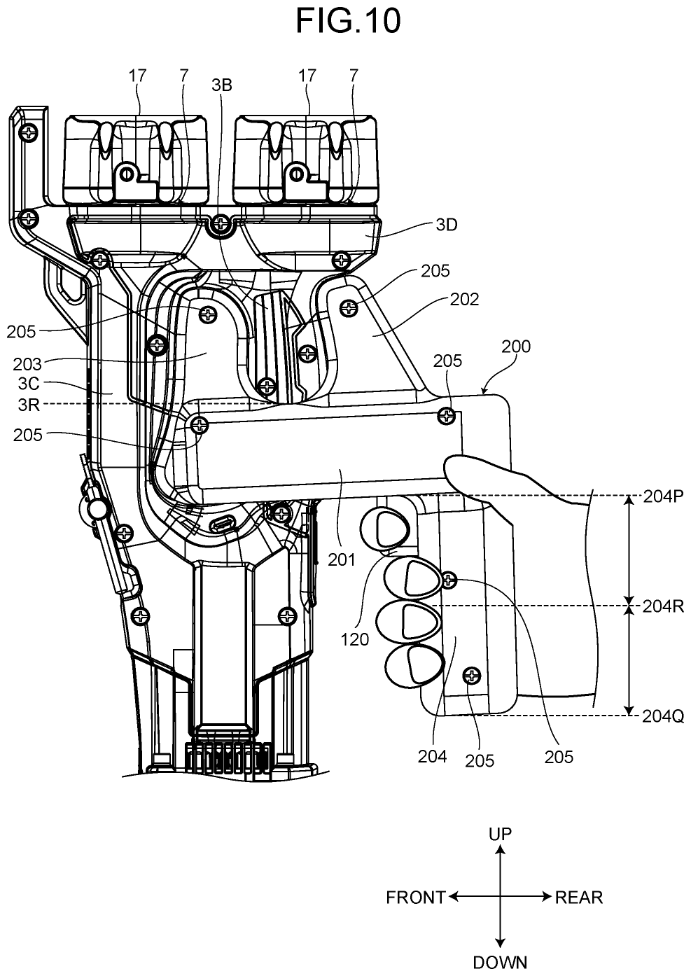

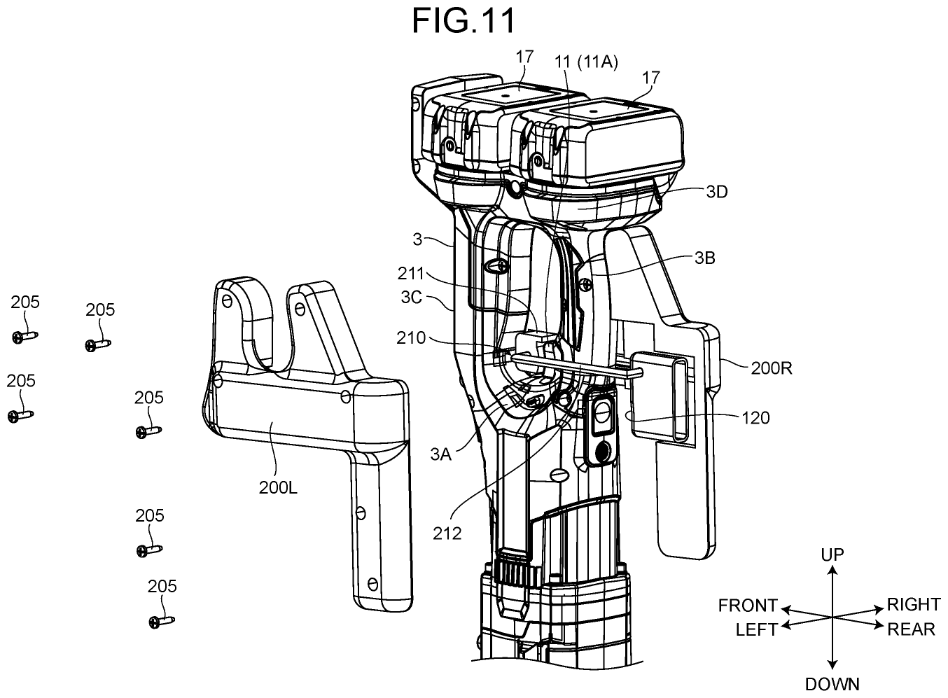

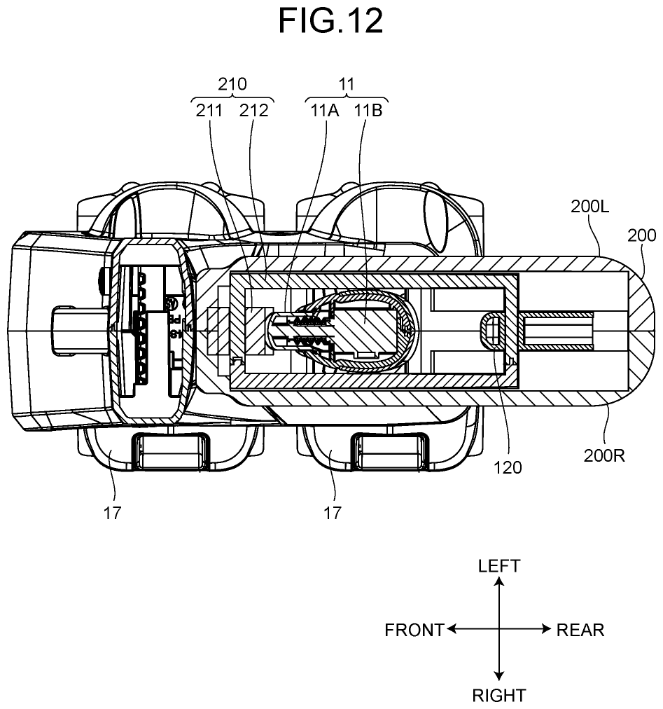

FIG. 8 is a front perspective view illustrating a rechargeable angle drill 1C according to the present embodiment. FIG. 9 is a rear perspective view illustrating the rechargeable angle drill 1C according to the present embodiment. FIG. 10 is a side view illustrating a part of the rechargeable angle drill 1C according to the present embodiment. FIG. 11 is an exploded perspective view illustrating a part of the rechargeable angle drill 1C according to the present embodiment. FIG. 12 is a cross-sectional view illustrating a rechargeable angle drill 1C according to the present embodiment. The rechargeable angle drill 1C according to the present embodiment can also be referred to as a rechargeable earth auger drill.

The rechargeable angle drill 1C includes: the trigger switch 11 including the trigger lever 11A (first trigger lever) and the switch circuit 11B (see FIGS. 11 and 12); the handle housing part 3 in which the trigger switch 11 is provided; an attachment housing part 200 mounted on the handle housing part 3; a trigger lever 120 (second trigger lever) provided in the attachment housing part 200; and a coupling mechanism 210 (see FIGS. 11 and 12) housed in the attachment housing part 200 and coupling the trigger lever 120 and the trigger lever 11A.

The trigger switch 11 is operated to start the motor 8. The trigger switch 11 is provided on the handle housing part 3. When the trigger lever 11A is pulled, the motor 8 is started. In the present embodiment, the trigger lever 11A is pulled via the coupling mechanism 210 by pulling the trigger lever 120 by the operator.

The trigger switch 11 including the trigger lever 11A and the switch circuit 11B is provided in the first handle part 3B. The trigger lever 11A is disposed to protrude forward from the front portion of the first handle part 3B.

The first handle part 3B has an internal space capable of housing the switch circuit 11B. The switch circuit 11B is housed in the first handle part 3B. The switch circuit 11B outputs operation signals when the trigger lever 11A is pulled. When the trigger lever 11A is pulled rearward in a state where the rechargeable angle drill 1C is activated, electric power is supplied from the battery pack 17 to the motor 8, and the motor 8 is started. The motor 8 is driven based on operation signals output from the switch circuit 11B. As in the above-described embodiment, the trigger lever 11A is biased forward by a biasing member. When the pulling operation of the trigger lever 11A is released, the trigger lever 11A moves forward and the motor 8 stops. When the operation and the operation release of the trigger lever 11A are switched, the driving and the stopping of the motor 8 are switched.

In the up-down direction, the trigger lever 11A is disposed downward of the center 3R of the handle housing part 3. In the present embodiment, the trigger lever 11A is disposed to protrude forward from the front portion of the lower portion of the first handle part 3B in the up-down direction. Similarly to the trigger lever 11A, the switch circuit 11B is disposed downward of the center 3R of the first handle part 3B in the up-down direction.

The attachment housing part 200 includes: a connection part 201 connected to the handle housing part 3; and a grip part 204 extending downward from a rear portion of the connection part 201. The upper end portion 204P of the grip part 204 is connected to the connection part 201. The lower end portion 204Q of the grip part 204 is open. In the up-down direction, the trigger lever 120 is disposed upward of a center 204R of the grip part 204.

The connection part 201 includes: a first connection part 202 disposed rearward of the first handle part 3B; and a second connection part 203 disposed between the first handle part 3B and the second handle part 3C. The grip part 204 is provided to extend downward from the first connection part 202. The trigger lever 120 is disposed to protrude forward from the front portion of the grip part 204.

The attachment housing part 200 includes: a first attachment housing part 200L, a second attachment housing part 200R that is disposed on the right side of the first attachment housing part 200L and sandwiches the handle housing part 3 with the first attachment housing part 200L, and a plurality of screws 205 that fix the first attachment housing part 200L and the second attachment housing part 200R.

The coupling mechanism 210 includes: a facing member 211 which faces the front surface of the trigger lever 11A; and a connection member 212 which connects the facing member 211 and the trigger lever 120 to each other. The connection member 212 has a frame shape. A front portion of the connection member 212 is fixed to the facing member 211. The rear portion of the connection member 212 is fixed to the trigger lever 120. The connection member 212 is guided in the front-rear direction by the inner surface of the attachment housing part 200. By pulling the trigger lever 120 rearward, the trigger lever 110A is pulled via the coupling mechanism 210.

As illustrated in FIG. 10, the operator can pull the trigger lever 120 rearward with the index finger so that the trigger lever 120 moves rearward while gripping the grip part 204 with the right hand, for example. By pulling the trigger lever 120 pulled rearward, the trigger lever 11A is pulled, so that the motor 8 is started. When the pulling operation of the trigger lever 120 is released, the trigger lever 120 moves forward together with the trigger lever 11A by the biasing force of the biasing member that biases the trigger lever 11A forward. When the pulling operation of the trigger lever 11A and the trigger lever 120 is released, the motor 8 is stopped.

### Effects

As described above, in the present embodiment, the rechargeable angle drill 1C may include: the motor 8, which includes the rotor 82 configured to rotate about the motor rotation axis MX extending in the up-down direction; the motor housing part 2, which houses the motor 8; the trigger lever 11A, which is the first trigger lever operated to start the motor 8; the handle housing part 3, which is disposed upward of the motor housing part 2 and in which the trigger lever 11A is provided; the speed reduction mechanism 14; the gear housing part 4, which is disposed downward of the motor housing part 2 and houses the speed reduction mechanism 14; the rotation output part 5, which protrudes forward from the gear housing part 4 and rotates about the output rotation axis DX orthogonal to the motor rotation axis MX based on the rotational force transmitted from the motor 8 via the speed reduction mechanism 14; the attachment housing part 200, which is mounted on the handle housing part 3; the trigger lever 120, which is the second trigger lever provided in the attachment housing part 200; and the coupling mechanism 210, which is housed in the attachment housing part 200 and couples the trigger lever 120 and the trigger lever 11A. The trigger lever 11A may be operated via the coupling mechanism 210 by operating (pulling) the trigger lever 120.

According to the above-mentioned configuration, the attachment housing part 200 is externally attached to the handle housing part 3. The operator can pull the trigger lever 11A provided in the handle housing part 3 by pulling the trigger lever 120 provided in the attachment housing part 200. Therefore, the operability of the rechargeable angle drill 1C is improved. Therefore, a lateral hole is formed in an excavation target with good operability.

In the present embodiment, the attachment housing part 200 may include: the connection part 201 connected to the handle housing part 3; and the grip part 204 extending downward from the rear portion of the connection part 201. In the up-down direction, the trigger lever 120 may be disposed upward of the center 204R of the grip part 204.

According to the above-mentioned configuration, the operator can pull the trigger lever 120 with the index finger. Therefore, the operability of the rechargeable angle drill 1C is improved.

In the present embodiment, the trigger lever 11A may be disposed downward of the center 3R of the handle housing part 3 in the up-down direction.

According to the above-mentioned configuration, the operability of the rechargeable angle drill 1C can be improved without changing the structure of the conventional trigger lever 11A.

In the present embodiment, the rechargeable angle drill 1C may include a battery mounting part 7, which is provided upward of the handle housing part 3 and to which the battery pack 17 is detachably attached. The handle housing part 3 may have a battery holding housing part 3D in which the battery mounting part 7 is provided. The handle housing part 3 may include: the first handle part 3B, which is connected to each of the motor housing part 2 and the battery holding housing part 3D; and the second handle part 3C, which is disposed forward of the first handle part 3B and connected to each of the motor housing part 2 and the battery holding housing part 3D. The connection part 201 may include: a first connection part 202 disposed behind the first handle part 3B; and a second connection part 203 disposed between the first handle part 3B and the second handle part 3C. The grip part 204 may be provided to extend downward from the first connection part 202. The trigger lever 120 may be disposed to protrude forward from the front portion of the grip part 204. The trigger lever 11A may be operated by pulling the trigger lever 120 rearward.

According to the above-mentioned configuration, the operator can pull the trigger lever 120 provided in the attachment housing part 200 with good operability.

In the present embodiment, the attachment housing part 200 may include a first attachment housing part 200L; a second attachment housing part 200R, which is disposed on the right side of the first attachment housing part 200L and sandwiches the handle housing part 3 with the first attachment housing part 200L; and a plurality of screws 205, which fix the first attachment housing part 200L and the second attachment housing part 200R.

According to the above-mentioned configuration, since the attachment housing part 200 has a so-called half housing structure, the attachment housing part 200 is smoothly mounted on the handle housing part 3.

### Fourth Embodiment

A fourth embodiment will be described. In the following description, the same or equivalent components as those of the above-described embodiments are denoted by the same reference numerals, and the description of the components is simplified or omitted.

### Rechargeable Angle Drill

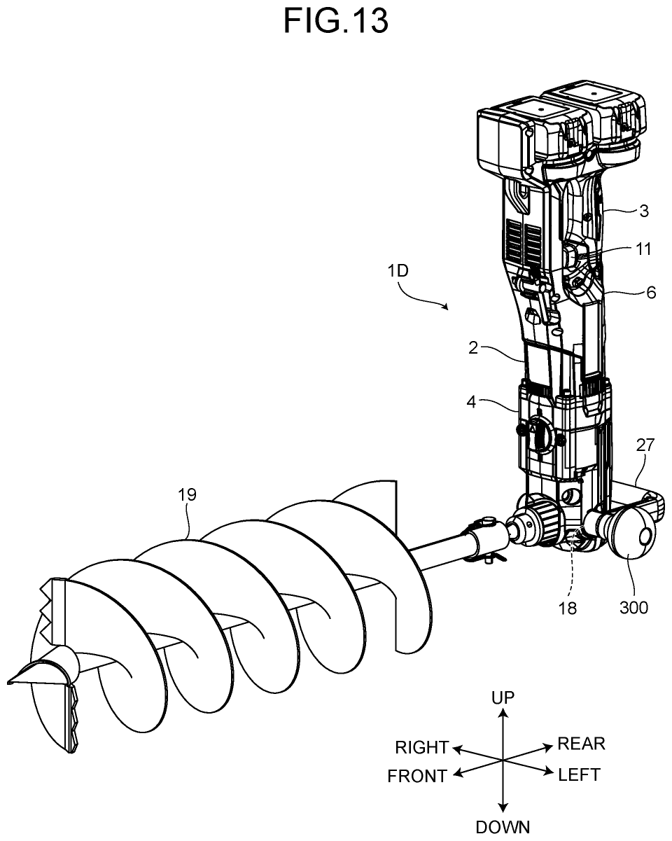

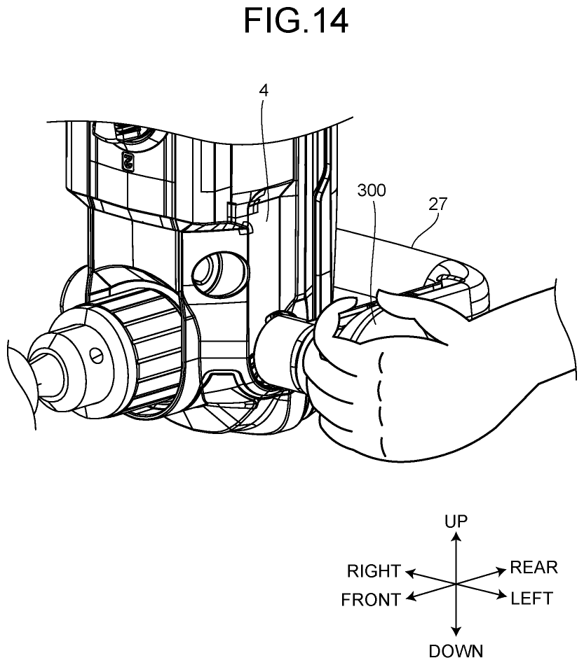

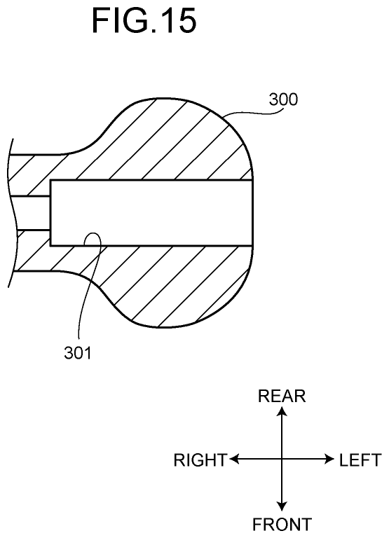

FIG. 13 is a front perspective view illustrating a rechargeable angle drill 1D according to the present embodiment. FIG. 14 is a perspective view illustrating the vicinity of the side handle 300 of the rechargeable angle drill 1D according to the present embodiment. FIG. 15 is a cross-sectional view illustrating a side handle 300 of the rechargeable angle drill 1D according to the present embodiment. The rechargeable angle drill 1D according to the present embodiment can also be referred to as a rechargeable earth auger drill.

In the present embodiment, the rechargeable angle drill 1D includes a spherical side handle 300 fixed to the gear housing part 4. The outer shape of the side handle 300 is spherical. The side handle 300 is fixed to the side portion of a gear housing part 4 by a screw. The side handle 300 has an insertion hole 301 into which a screw is inserted. The screw inserted into the insertion hole 301 is inserted into a screw hole 18. When the screw inserted into the insertion hole 301 is coupled to the screw hole 18, the side handle 300 is fixed to the side portion of the gear housing part 4. In the example illustrated in FIGS. 13 and 14, the side handle 300 is fixed to the left portion of the gear housing part 4. That is, the screw is coupled to the screw hole 18 provided in the left portion of the gear housing part 4.

As illustrated in FIG. 14, the side handle 300 is fixed to the left portion of the gear housing part 4, so that operator can hold the side handle 300 with the left hand from the left side of the side handle 300. The operator can operate a trigger lever 11A (110A, 120) by gripping the first handle part 3B with the right hand.

In the present embodiment, both the side handle 300 and the rear handle 27 are fixed to the gear housing part 4 by screws inserted into the screw holes 18. That is, the side handle 300 and the rear handle 27 are fastened together to the gear housing part 4 by screws.

The side handle 300 may be fixed to the right portion of the gear housing part 4.

### Effects

As described above, in the present embodiment, the rechargeable angle drill 1D may include the spherical side handle 300 fixed to the gear housing part 4.

According to the above-mentioned configuration, the operator can easily grip the side handle 300. In addition, in the front-rear direction, the side handle 300 is disposed at a position closer to the center (center of gravity) of the rechargeable angle drill 1D than the rear handle 27. The operator can operate the rechargeable angle drill 1D with good operability by gripping the side handle 300.

### Fifth Embodiment

A fifth embodiment will be described. In the following description, the same or equivalent components as those of the above-described embodiments are denoted by the same reference numerals, and the description of the components is simplified or omitted.

### Rechargeable Angle Drill

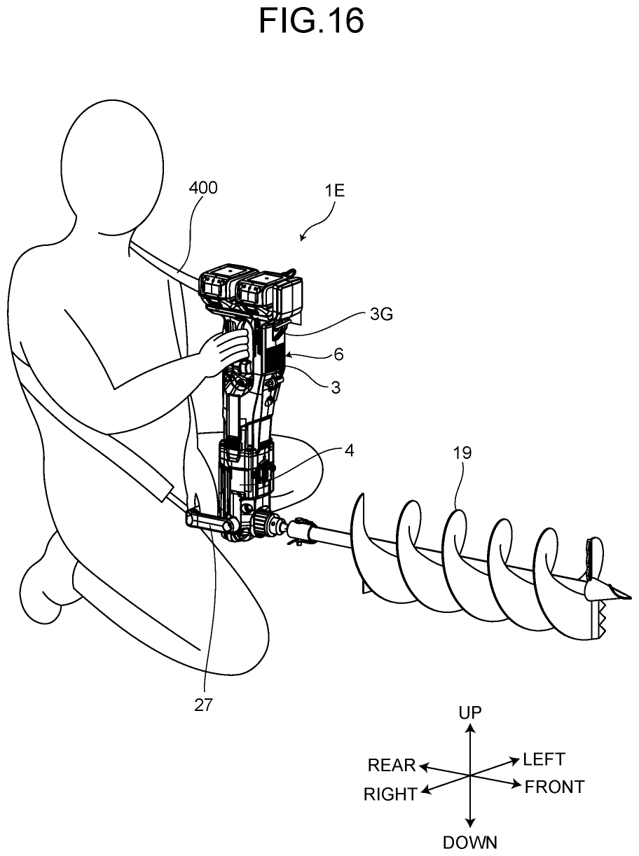

FIG. 16 is a right front perspective view illustrating a rechargeable angle drill 1E according to the present embodiment. The rechargeable angle drill 1E according to the present embodiment can also be referred to as a rechargeable earth auger drill. As illustrated in FIG. 16, the rechargeable angle drill 1E includes a belt 400 that is hung on the shoulder of the operator. A left end portion of the belt 400 is coupled to a handle housing part 3, and a right end portion of the belt 400 is coupled to a gear housing part 4 or a rear handle 27 provided in the gear housing part 4. In the example illustrated in FIG. 16, an annular part 3G is provided at the upper portion of the front portion of the handle housing part 3. A carabiner is hung on the annular part 3G. The left end portion of the belt 400 is coupled to the annular part 3G of the handle housing part 3 via the carabiner. A right end portion of the belt 400 is coupled to the rear handle 27. The belt 400 is hung on the left shoulder of the operator.

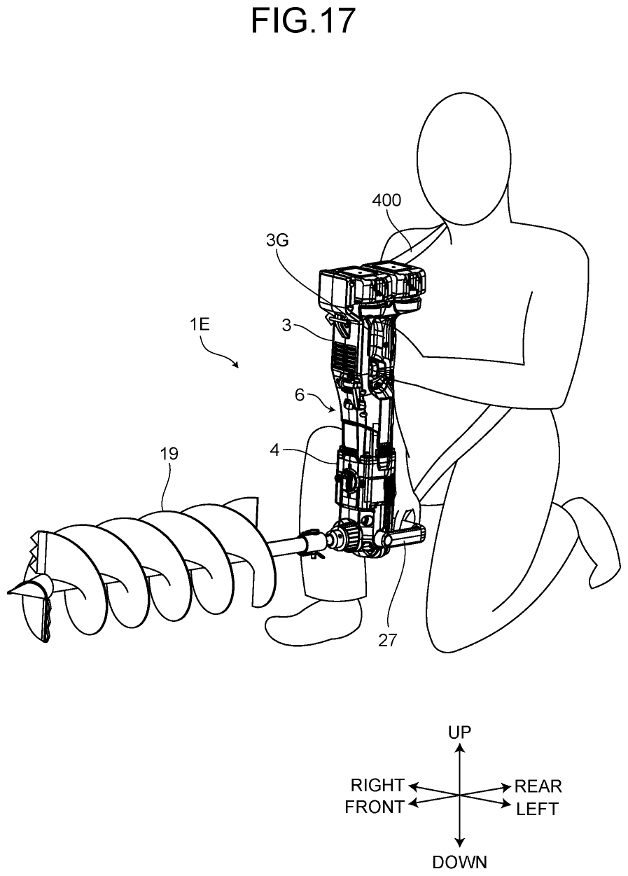

FIG. 17 is a left front perspective view illustrating the rechargeable angle drill 1E according to the present embodiment. As illustrated in FIG. 17, the left end portion of the belt 400 may be fixed to a rear handle 27 fixed to the gear housing part 4, and the right end portion of the belt 400 may be coupled to the annular part 3G of the handle housing part 3 via the carabiner. In the example illustrated in FIG. 17, the belt 400 is hung on the right shoulder of the operator.

### Effects

As described above, in the present embodiment, the rechargeable angle drill 1E may include the belt 400 having one end portion coupled to the handle housing part 3 and the other end portion coupled to the gear housing part 4 or the rear handle 27 provided in the gear housing part 4.

According to the above-mentioned configuration, the operator can support the rechargeable angle drill 1D with the shoulder via the belt 400 by hooking the belt 400 on the shoulder. The operator can receive the weight of the rechargeable angle drill 1D on the shoulder or receive the torque acting on the rechargeable angle drill 1D.

### Sixth Embodiment

A sixth embodiment will be described. In the following description, the same or equivalent components as those of the above-described embodiments are denoted by the same reference numerals, and the description of the components is simplified or omitted.

### Rechargeable Earth Auger Drill

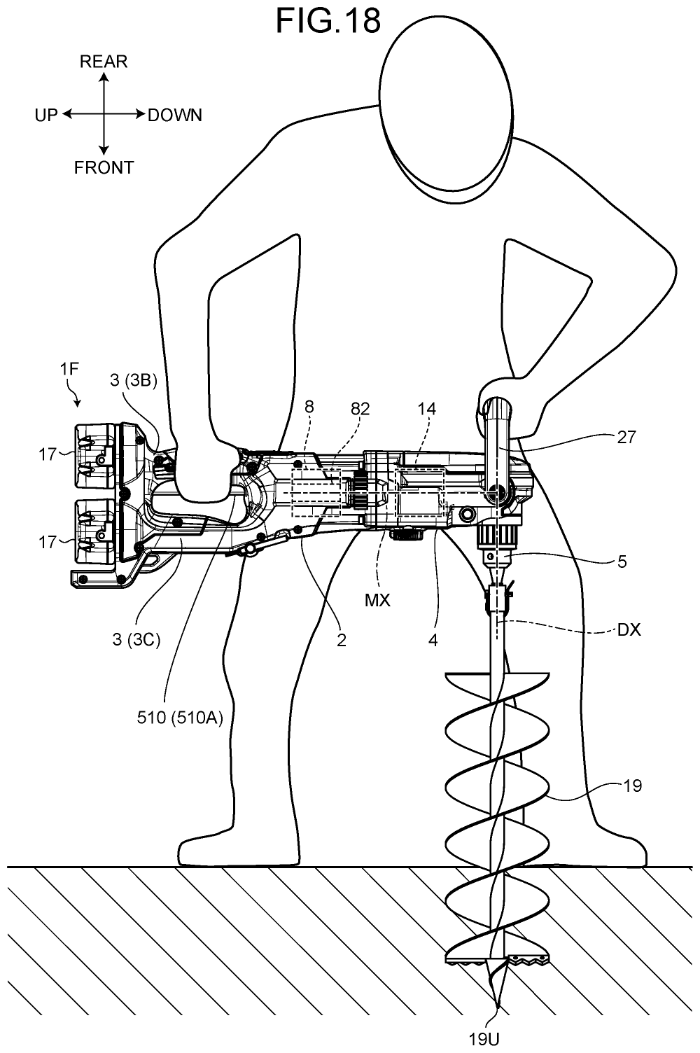

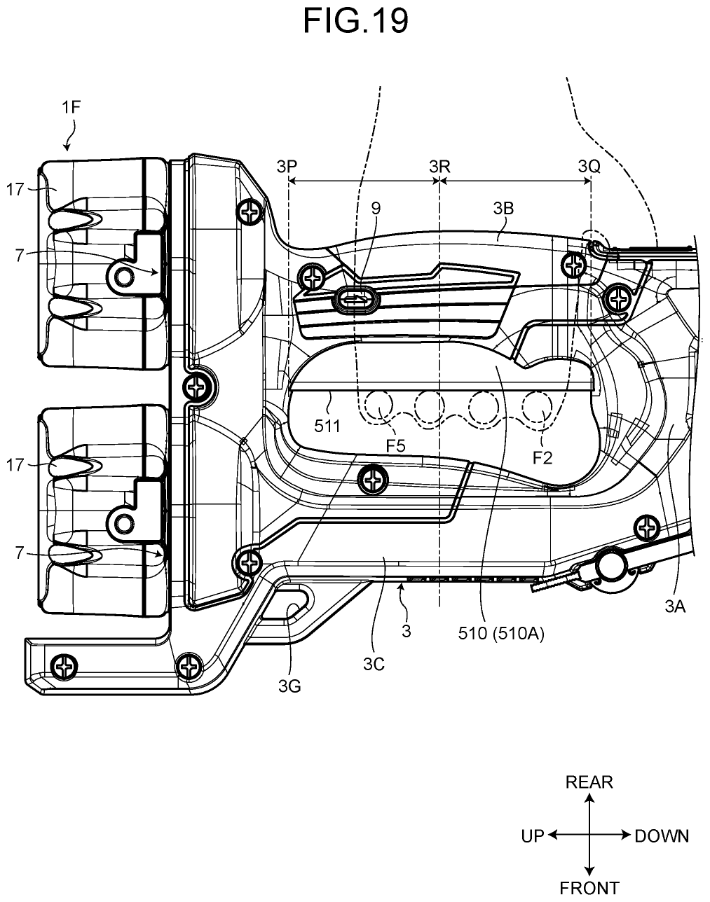

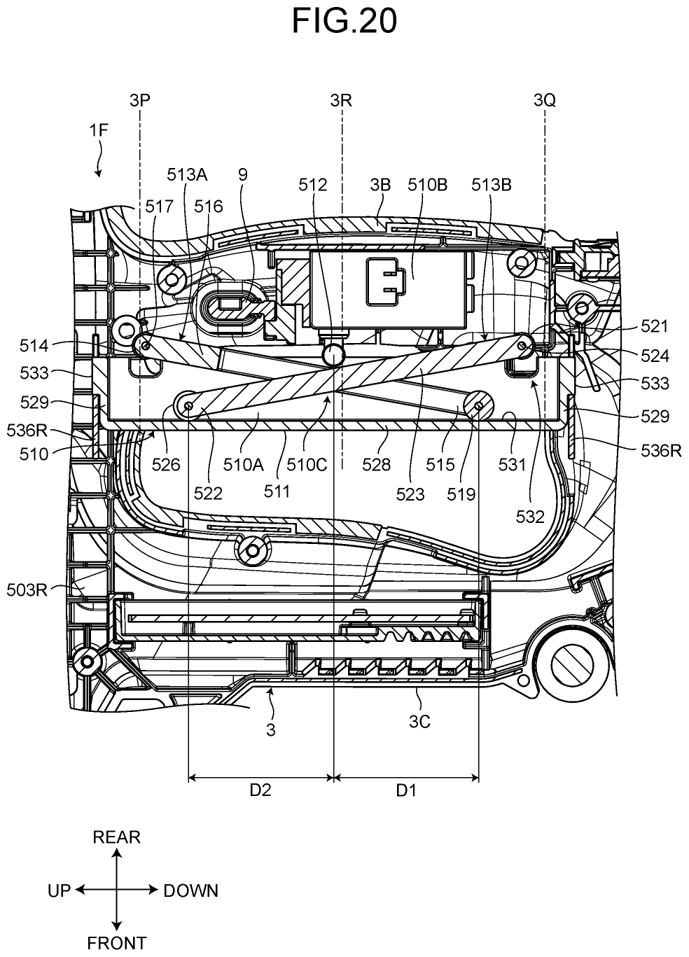

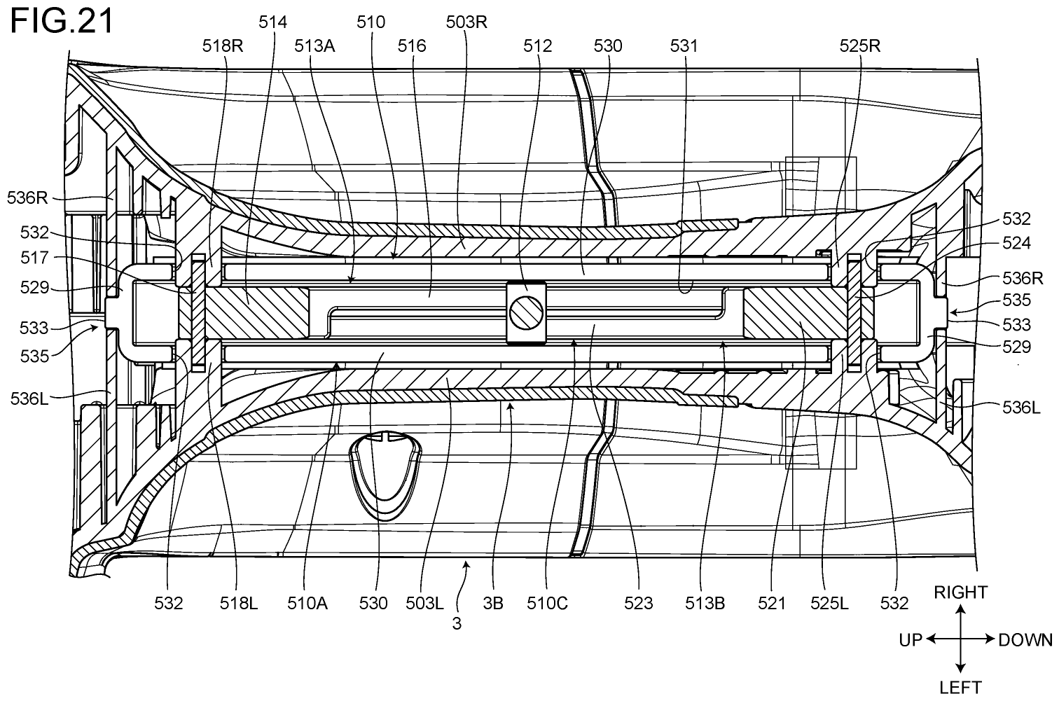

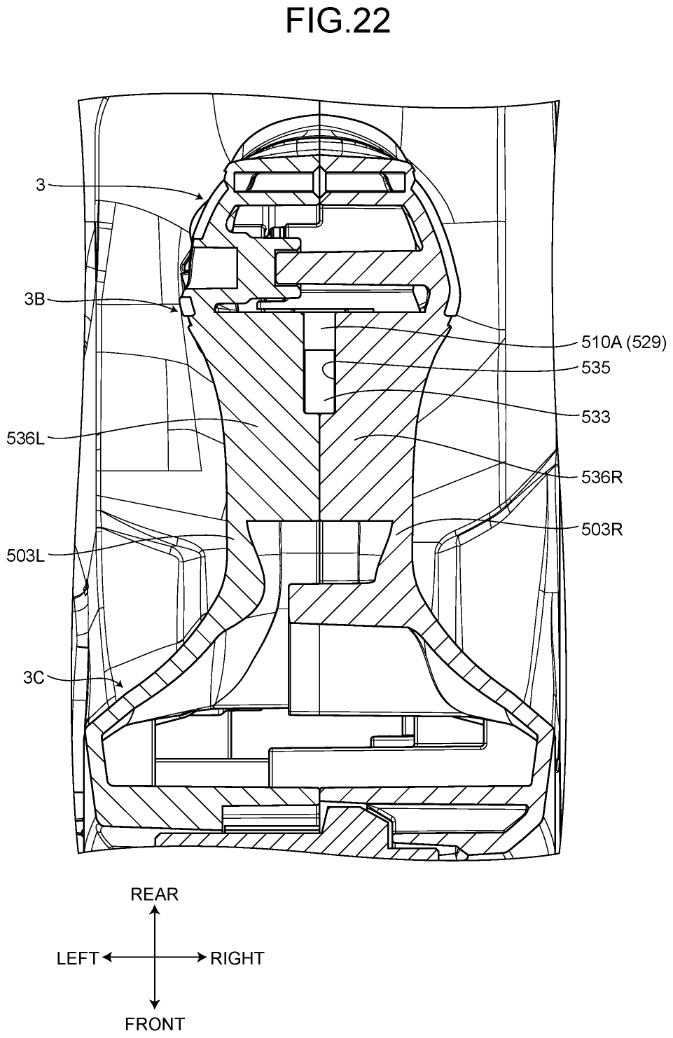

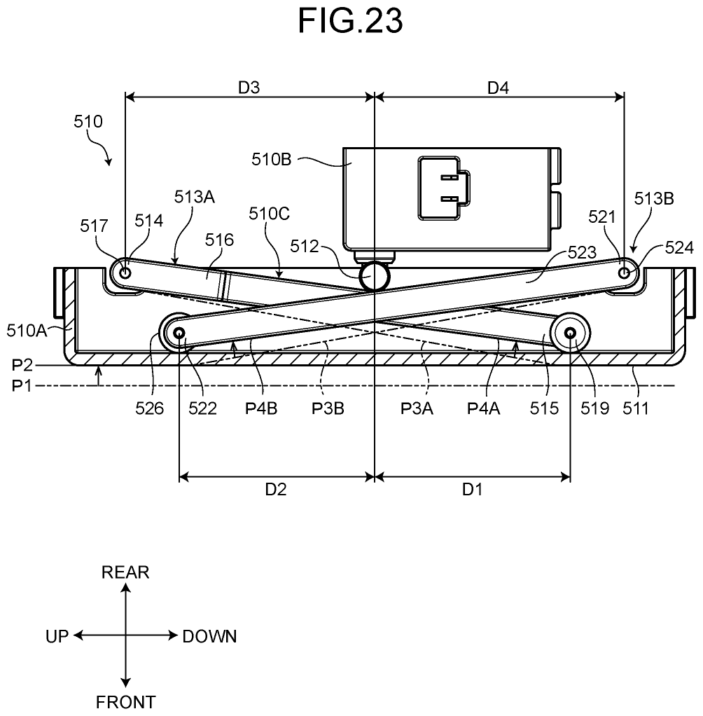

FIG. 18 is a side view for explaining a method of using a rechargeable earth auger drill 1F according to the sixth embodiment. FIG. 19 is a side view illustrating the vicinity of a trigger lever 510A of the rechargeable earth auger drill 1F according to the sixth embodiment. FIG. 20 is a cross-sectional view illustrating an inside of a first handle part 3B provided with the trigger switch 510 according to the sixth embodiment. FIG. 21 is a cross-sectional view taken along the up-down direction passing through the pivot shaft of a link mechanism 510C according to the sixth embodiment. FIG. 22 is a cross-sectional view of a guide protrusion 533 of the trigger lever 510A according to the sixth embodiment taken along the left-right direction. FIG. 23 is a cross-sectional view illustrating a state in which the trigger lever 510A according to the sixth embodiment is pulled.

The structure of the rechargeable earth auger drill 1F is basically similar to that of the rechargeable angle drill 1A. The rechargeable earth auger drill 1F can be used to form not only lateral holes but also vertical holes in an excavation target. In the case of forming the vertical hole, the rechargeable earth auger drill 1F is used in a state where a motor housing part 2, a handle housing part 3, and a gear housing part 4 are arranged sideways (horizontal direction). That is, the rechargeable earth auger drill 1F is used in the horizontal placement state. The rotation output part 5 is disposed vertically below the motor housing part 2, the handle housing part 3, and the gear housing part 4, and the rotation output part 5 is directed vertically downward. In the example illustrated in FIG. 18, the operator grips the first handle part 3B with the right hand and grips the rear handle 27 with the left hand.

The operator pulls the trigger lever 510A with the right hand holding the first handle part 3B. When the trigger lever 510A is pulled, the rotation output part 5 rotates with the drill bit 19 attached.

The operator presses a front end portion 19U of the rotating drill bit 19 against the excavation target existing vertically below the rechargeable earth auger drill 1F. When the rotating drill bit 19 is pressed against the excavation target, the excavation target is excavated, and the vertical hole is formed in the excavation target. The operator pushes the rechargeable earth auger drill 1F vertically downward in a state where the drill bit 19 is rotating.

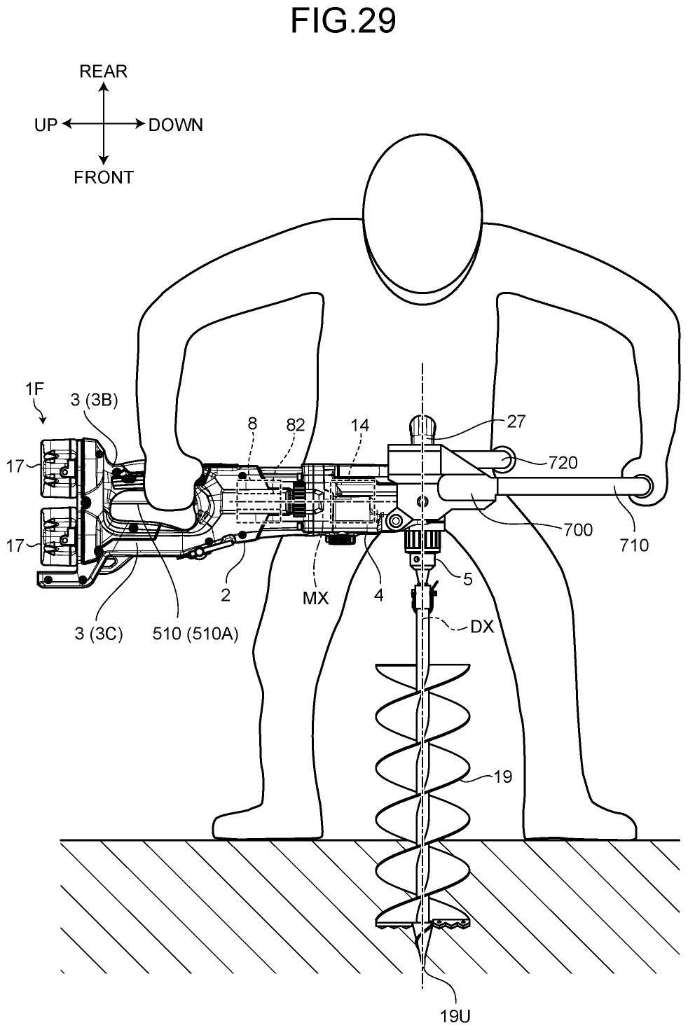

The rechargeable earth auger drill 1F can also be used by attaching a loop handle 710. FIG. 29 is a side view for explaining another method of using the rechargeable earth auger drill 1F. The rechargeable earth auger drill 1F includes a detachable loop handle 710 and a reaction force receiving bar 720. The loop handle 710 and the reaction force receiving bar 720 are provided in a mounting part 700. The mounting part 700 is an attachment attachable to and detachable from the gear housing part 4. The loop handle 710 is formed in a loop shape by fixing both ends to the mounting part 700. The loop handle 710 protrudes downward with respect to the gear housing part 4. The reaction force receiving bar 720 is selectively attachable to and detachable from either the right side surface or the left side surface of the mounting part 700. When the operator grips the first handle part 3B with the right hand, the reaction force receiving bar 720 is mounted on the right side surface of the mounting part 700. The reaction force receiving bar 720 protrudes rightward with respect to the gear housing part 4. The reaction force receiving bar 720 comes into contact with the waist of the operator. The reaction force receiving bar 720 enables the operator's waist to support the rotational reaction force acting on the drill bit 19 from the excavation target.

In the example illustrated in FIG. 29, the operator grips the first handle part 3B with the right hand and grips the loop handle 710 with the left hand. The operator holds the rechargeable earth auger drill 1F so that the reaction force receiving bar 720 comes into contact with the waist. The operator presses a front end portion 19U of the rotating drill bit 19 against the excavation target existing vertically below the rechargeable earth auger drill 1F. When the rotating drill bit 19 is pressed against the excavation target, the excavation target is excavated, and the vertical hole is formed in the excavation target. The operator pushes the rechargeable earth auger drill 1F vertically downward in a state where the drill bit 19 is rotating. A reaction force in a direction rotating about the output rotation axis DX acts on the drill bit 19 from the excavation target. In addition to both hands, the operator receives the reaction force with the waist by the reaction force receiving bar 720, and maintains the posture of the rechargeable earth auger drill 1F. When the reaction force at the time of excavation is large, excavation by the use method of FIG. 29 is stabilized.

In FIG. 18, the operator may grip the first handle part 3B with the left hand and grip the rear handle 27 with the right hand. The operator pulls the trigger lever 510A with the left hand gripping the first handle part 3B. In FIG. 29, the operator may grip the first handle part 3B with the left hand and grip the loop handle 710 with the right hand. In this case, the operator pulls the trigger lever 510A with the left hand holding the first handle part 3B. When the operator grips the first handle part 3B with the left hand, the reaction force receiving bar 720 is mounted on the left side surface of the mounting part 700.

In FIG. 19, the position of fingers on the first handle part 3B when used in the horizontal placement state is indicated by a dotted line. In the case of use in the horizontal placement state, the position of fingers on the first handle part 3B is opposite to that in the case of use in the vertical placement state. That is, when the rechargeable earth auger drill 1F is used in the vertical placement state to form the lateral hole (see FIG. 4), the index finger is positioned on the upper end portion 3P side of the first handle part 3B and the little finger is positioned on the lower end portion 3Q side as in FIG. 6. In contrast, when the rechargeable earth auger drill 1F is used in the horizontal placement state to form the vertical hole, as illustrated in FIG. 19, the index finger F2 is positioned on the lower end portion 3Q side of the first handle part 3B, and the little finger F5 is positioned on the upper end portion 3P side.

In the operation of gripping the object such as the pulling operation of the trigger switch 510, generally, the index finger F2 easily applies the force, and the little finger F5 hardly applies the force. Therefore, in the case of use in the vertical placement state (see FIG. 6), the position on the upper end portion 3P side where the index finger is positioned is the main pressing point of the pulling operation. In the case of use in the horizontal placement state (see FIG. 19), the position on the lower end portion 3Q side where the index finger F2 is positioned is the main pressing point of the pulling operation.

However, in the lever-type trigger switch or the like, the distance from the rotation shaft to the pressing point is different between the case where the portion on the upper end portion 3P side of the trigger lever is pulled and the case where the portion on the lower end portion 3Q side of the trigger lever is pulled. Therefore, the magnitude of the force required for the pulling operation changes. That is, due to the change in the magnitude of the force required for the pulling operation between the case of using the rechargeable earth auger drill in the vertical placement state and the case of using the rechargeable earth auger drill in the horizontal placement state, the operability of one is deteriorated as compared with the other. It is desirable to improve the operability of the rechargeable earth auger drill by reducing the difference in required operating force between the case of using the rechargeable earth auger drill in the vertical placement state and the case of using the rechargeable earth auger drill in the horizontal placement state.

Therefore, the rechargeable earth auger drill 1F according to the sixth embodiment can approximate the force required for the trigger operation at each position of the pressing point. The trigger switch 510 is configured such that the magnitude of the operating force for operating the trigger lever 510A is brought close to each other between the position on the upper end portion (first end portion) 3P side of the center 3R of the handle part (first handle part 3B) and the position on the lower end portion (second end portion) 3Q side of the center 3R of the pressing surface 511.

The trigger switch 510 is operated by the operator to start the motor 8. The trigger switch 510 is provided on the handle housing part 3. The trigger switch 510 includes the trigger lever 510A, the switch circuit 510B, and the link mechanism 510C.

The trigger switch 510 is provided in the handle part of the handle housing part 3. The trigger switch 510 is provided in the first handle part 3B. The trigger lever 510A is disposed to protrude forward from the front portion of the first handle part 3B. When the trigger lever 510A is pulled rearward, the motor 8 is started.

The first handle part 3B has an internal space capable of housing the switch circuit 510B. The switch circuit 510B is housed in the first handle part 3B. The switch circuit 510B outputs operation signals when the trigger lever 510A is pulled. When the trigger lever 510A is pulled rearward in a state where the rechargeable earth auger drill 1F is activated, electric power is supplied from the battery pack 17 to the motor 8, and the motor 8 is started. The motor 8 is driven based on operation signals output from the switch circuit 510B. When the operation and the operation release of the trigger lever 510A are switched, the driving and the stopping of the motor 8 are switched.

In the up-down direction, one end portion (first end portion) of the trigger lever 510A is disposed on the upper end portion 3P side from the center 3R of the first handle part 3B. The other end portion (second end portion) of the trigger lever 510A is disposed on the lower end portion 3Q side from the center 3R of the first handle part 3B. In the present embodiment, the trigger lever 510A is provided to extend from the upper end portion 3P to the lower end portion 3Q of the first handle part 3B.

The trigger lever 510A has a pressing surface 511. The pressing surface 511 is a front surface of the trigger lever 510A. The pressing surface 511 extends along the first handle part 3B. The pressing surface 511 is formed over the upper end portion 3P side of the first handle part 3B and the lower end portion 3Q side of the first handle part 3B across the center 3R of the first handle part 3B. In the present embodiment, the pressing surface 511 extends from the upper end portion 3P of the first handle part 3B to the lower end portion 3Q of the first handle part 3B. The pressing surface 511 is continuous from the upper end portion 3P to the lower end portion 3Q of the first handle part 3B. The operator can press the trigger lever 510A for performing the pulling operation at any position between the upper end portion 3P and the lower end portion 3Q.

The switch circuit 510B is disposed near the center 3R of the first handle part 3B in the up-down direction. The switch circuit 510B has an actuating part 512 that is moved by a pulling operation. The actuating part 512 moves forward and rearward in the front-rear direction. The actuating part 512 is biased forward by a biasing member built in the switch circuit 510B. When the actuating part 512 moves rearward from the forward limit, an input operation to the switch circuit 510B is performed. The actuating part 512 is disposed near the center 3R of the first handle part 3B in the up-down direction. The actuating part 512 is closer to the center 3R than the upper end portion 3P of the first handle part 3B. The actuating part 512 is closer to the center 3R than the lower end portion 3Q of the first handle part 3B. The actuating part 512 is disposed at the center of the trigger lever 510A in the up-down direction.

The forward/reverse switching lever 9 is disposed in the first handle part 3B. The forward/reverse switching lever 9 is movable in the left-right direction. The forward/reverse switching lever 9 is movable to three positions of a position on one side and a position on the other side in the left-right direction, and an intermediate position. The forward/reverse switching lever 9 is connected to the switch circuit 510B. In response to the forward/reverse switching lever 9 being disposed at the position on one side, the switch circuit 510B is switched to a forward rotation state. In response to the forward/reverse switching lever 9 being disposed at the position on the other side, the switch circuit 510B is switched to a reverse rotation state. In response to the forward/reverse switching lever 9 being disposed at the intermediate position, the switch circuit 510B is switched to a locked state. When the switch circuit 510B is in the forward rotation state, the motor 8 is driven to rotate forward by the pulling operation. When the switch circuit 510B is in the reverse rotation state, the motor 8 is reversely driven by the pulling operation. When the switch circuit 510B is in the locked state, the trigger lever 510A is fixed. Therefore, when the forward/reverse switching lever 9 is at the intermediate position, the trigger lever 510A does not move even if the operator performs the pulling operation.

At least a part of the link mechanism 510C is housed in the first handle part 3B. The link mechanism 510C is operably provided in the first handle part 3B. The link mechanism 510C supports the trigger lever 510A to be movable according to the action of the operating force on the pressing surface 511. The link mechanism 510C is in contact with the trigger lever 510A. The link mechanism 510C receives an operating force by the pulling operation via the trigger lever 510A. As a result, the link mechanism 510C and the trigger lever 510A move in conjunction with each other. The link mechanism 510C supports the trigger lever 510A to be translationally movable with respect to the switch circuit 510B in cooperation with a guide part 535 described later. The link mechanism 510C is in contact with the actuating part 512. The link mechanism 510C presses the actuating part 512 rearward in accordance with the pulling operation. An input to the switch circuit 510B is executed by the rearward movement of the actuating part 512.

The link mechanism 510C includes a first arm 513A and a second arm 513B. The link mechanism 510C according to the present embodiment is a crosslink mechanism in which the first arm 513A and the second arm 513B intersect with each other. The first arm 513A has a rod-like shape.

The first arm 513A has a first end portion 514, a second end portion 515 opposite to the first end portion 514, and an intermediate portion 516. The first end portion 514 is rotatably supported by a pivot shaft 517. The pivot shaft 517 is disposed closer to the upper end portion 3P of the first handle part 3B than the actuating part 512 of the switch circuit 510B. The pivot shaft 517 is disposed behind the trigger lever 510A. The pivot shaft 517 is a shaft member that is held by the first handle part 3B and extends in the left-right direction. The pivot shaft 517 passes through an insertion hole formed in the first end portion 514. Both end portions of the pivot shaft 517 are supported by a boss part 518R and a boss part 518L, respectively. The boss part 518R and the boss part 518L are formed on the inner surface of the first handle part 3B. The intermediate portion 516 connects the first end portion 514 and the second end portion 515. The intermediate portion 516 is disposed between the switch circuit 510B and the trigger lever 510A in the front-rear direction. The intermediate portion 516 extends from the upper end portion 3P side of the first handle part 3B to the lower end portion 3Q side beyond the center 3R. The intermediate portion 516 is linear. The second end portion 515 is a free end. The second end portion 515 is disposed on the lower end portion 3Q side from the center 3R of the first handle part 3B. A roller 519 rotatable about an axis in the left-right direction is mounted on the second end portion 515. The roller 519 is in contact with the inner surface of the trigger lever 510A.

In this manner, the first arm 513A extends obliquely downward from the pivot shaft 517 toward the inner surface of the trigger lever 510A. The first arm 513A is rotatable about a pivot shaft 517. The first arm 513A is rotatable in a direction approaching the switch circuit 510B and a direction approaching the trigger lever 510A.

The second arm 513B has a first end portion 521, a second end portion 522 opposite to the first end portion 521, and an intermediate portion 523. The first end portion 521 is rotatably supported by a pivot shaft 524. The pivot shaft 524 is disposed closer to the lower end portion 3Q side of the first handle part 3B than the actuating part 512 of the switch circuit 510B. The pivot shaft 524 is disposed behind the trigger lever 510A. The pivot shaft 524 is a shaft member mounted on the first handle part 3B and extending in the left-right direction. The pivot shaft 524 passes through an insertion hole formed in the first end portion 521. Both end portions of the pivot shaft 524 are supported by a boss part 525R and a boss part 525L, respectively. The boss part 525R and the boss part 525L are formed on the inner surface of the first handle part 3B. The intermediate portion 523 connects the first end portion 521 and the second end portion 522. The intermediate portion 523 is disposed between the switch circuit 510B and the trigger lever 510A. The intermediate portion 523 extends from the lower end portion 3Q side of the first handle part 3B to the upper end portion 3P side across the center 3R. The intermediate portion 523 is linear. The second end portion 522 is a free end. The second end portion 522 is disposed on the upper end portion 3P side from the center 3R of the first handle part 3B. A roller 526 rotatable about an axis in the left-right direction is mounted on the second end portion 522. The roller 526 is in contact with the inner surface of the trigger lever 510A.

In this manner, the second arm 513B extends obliquely upward from the pivot shaft 524 toward the inner surface of the trigger lever 510A. The second arm 513B is rotatable about the pivot shaft 524. The second arm 513B is rotatable in a direction approaching the switch circuit 510B and a direction approaching the trigger lever 510A.

The first arm 513A and the second arm 513B intersect with each other at their respective intermediate portions 516 and 523. The intermediate portion 516 is disposed on the right side with respect to the intermediate portion 523. Alternatively, the intermediate portion 516 may be disposed on the left side with respect to the intermediate portion 523. The first arm 513A can be brought into contact with the trigger lever 510A by the roller 519 at a position on the lower end portion 3Q side from the center 3R of the first handle part 3B. The second arm 513B can be brought into contact with the trigger lever 510A by the roller 526 at a position on the upper end portion 3P side from the center 3R of the first handle part 3B. As a result, the link mechanism 510C supports the trigger lever 510A at a first support position on the upper end portion 3P side from to the center 3R of the first handle part 3B and at a second support position on the lower end portion 3Q side from the center 3R.

The first arm 513A is contactable with the actuating part 512 at the intermediate portion 516, and the second arm 513B is contactable with the actuating part 512 at the intermediate portion 523. A distal end of the actuating part 512 extends in the left-right direction to be contactable with both the intermediate portion 516 and the intermediate portion 523. The distal end of the actuating part 512 has a cylindrical shape. The first arm 513A and the second arm 513B are vertically symmetrical with respect to a straight line in the front-rear direction passing through the actuating part 512 of the switch circuit 510B. In the up-down direction, a distance D1 from the center of the actuating part 512 to the center of the roller 519 is equal to a distance D2 from the center of the actuating part 512 to the center of the roller 526. In the up-down direction, a distance D3 (see FIG. 23) from the center of the actuating part 512 to the pivot shaft 517 is equal to a distance D4 (see FIG. 23) from the center of the actuating part 512 to the pivot shaft 524.

The trigger lever 510A has: a front surface 528 on which the pressing surface 511 is formed; upper and lower side surfaces 529, which are both surfaces in the up-down direction; and left and right side surfaces 530, which are both surfaces in the left-right direction. The trigger lever 510A has a recessed portion 531 recessed forward from the rear surface. At least a part of the link mechanism 510C is disposed in the recessed portion 531. At the rear end portions of the left and right side surfaces 530, notches 532 for avoiding contact between the trigger lever 510A and the boss part 518R, the boss part 518L, the boss part 525R, and the boss part 525L when the trigger lever 510A moves forward and rearward are formed. Guide protrusions 533 protruding outward are formed on the upper and lower side surfaces 529, respectively. That is, the guide protrusion 533 is provided on each of the upper end surface and the lower end surface of the trigger lever 510A.

As illustrated in FIGS. 21 and 22, the first handle part 3B includes guide part 535 that guides the guide protrusion 533. The guide part 535 is provided each in the vicinity of the upper end portion 3P and in the vicinity of the lower end portion 3Q of the first handle part 3B. Each guide part 535 comes into contact with the guide protrusion 533 of the trigger lever 510A, and guides the trigger lever 510A to move in the front-rear direction. The guide part 535 is provided on a wall portion partitioning the inside of the first handle part 3B.

Specifically, the handle housing part 3 has a left-right split structure. The handle housing part 3 is divided into a left housing 503L and a right housing 503R. A left wall portion 503L is formed in the left housing 536L, and a right wall portion 503R is formed in the right housing 536R. The left wall portion 536L and the right wall portion 536R face each other in the left-right direction. A notch is formed at each of the right end portion of the left wall portion 536L and the left end portion of the right wall portion 536R. The guide part 535 is configured by an end surface of the notch. The guide part 535 extends linearly in the front-rear direction. The guide protrusion 533 of the trigger lever 510A is disposed in the guide part 535. As a result, the guide protrusions 533 are restricted from moving in the up-down direction and the left-right direction by the notch-shaped guide parts 535, and are guided to be movable in the front-rear direction. As a result, the trigger lever 510A can be translated in the front-rear direction by the guide protrusions 533 being guided by the guide parts 535.

When the trigger lever 510A is pulled, an operating force directed rearward is applied on the pressing surface 511 by the operator's fingers. The trigger lever 510A transmits the operating force to the second end portion 515 of the first arm 513A and the second end portion 522 of the second arm 513B. The first arm 513A and the second arm 513B pivot in a direction approaching the switch circuit 510B by the operating force. The trigger lever 510A is guided by the guide part 535 to translate rearward while pivoting the first arm 513A and the second arm 513B. The actuating part 512 of the switch circuit 510B is pushed rearward by the pivoting of the first arm 513A and the second arm 513B. The switch circuit 510B outputs operation signals by the rearward movement of the actuating part 512. As illustrated in FIG. 23, the trigger lever 510A moves from an initial position P1 to a rearward limit P2 by the pulling operation. The first arm 513A and the second arm 513B pivot in a direction approaching the switch circuit 510B from initial positions P3A and P3B and move to positions P4A and P4B, respectively.

While the trigger lever 510A moves rearward, the roller 519 and the roller 526 roll along the inner surface of the trigger lever 510A to change the contact position with the trigger lever 510A. The roller 519 and the roller 526 are displaced in a direction away from the actuating part 512 of the switch circuit 510B as the trigger lever 510A moves rearward. The roller 519 and the roller 526 move symmetrically with respect to the actuating part 512 of the switch circuit 510B. That is, the distance D1 and the distance D2 maintain the same relationship. The link mechanism 510C evenly supports the rearward movement of the trigger lever 510A by the first arm 513A and the second arm 513B during the pulling operation. As a result, regardless of which of the position on the upper end portion 3P side and the position on the lower end portion 3Q side of the pressing surface 511 the operating force acts, the operating force required for the pulling operation (rearward movement) of the trigger lever 510A is equalized.

Therefore, in the present embodiment, the operating force required for the pulling operation of the trigger lever 510A is substantially equal regardless of which finger illustrated in FIG. 19 performs the pulling operation. More specifically, the link mechanism 510C supports the trigger lever 510A such that the operating force required for the pulling operation of the trigger lever 510A becomes substantially equal regardless of which position from one end portion (first end portion) to the other end portion (second end portion) of the pressing surface 511 is the pressing point.

When the pulling operation is finished and the operating force is no longer applied, the actuating part 512 returns to the forward limit by the biasing member. The first arm 513A and the second arm 513B of the link mechanism 510C, and the trigger lever 510A are pushed back as the actuating part 512 returns to the forward limit, and return to the initial positions on the front side.

### Effects

As described above, in the present embodiment, the rechargeable earth auger drill 1F includes: the motor 8, which includes the rotor 82 configured to rotate about the motor rotation axis MX; the motor housing part 2, which houses the motor 8; the trigger switch 510, which includes the trigger lever 510A to be operated to start the motor 8, the handle housing part 3, which is disposed on one side (first side) with respect to the motor housing part 2 in a direction of the motor rotation axis MX and includes the handle part (first handle part 3B) in which the trigger switch 510 is provided; the speed reduction mechanism 14; the gear housing part 4, which is disposed on the other side (second side) with respect to the motor housing part in the direction of the motor rotation axis MX 2 and houses the speed reduction mechanism 14; and the rotation output part 5, which protrudes from the gear housing part 4 and rotates about the output rotation axis DX orthogonal to the motor rotation axis MX based on the rotational force transmitted from the motor 8 via the speed reduction mechanism 14. The trigger lever 510A has the pressing surface 511 formed over the upper end portion (first end portion) 3P side and the lower end portion (second end portion) 3Q side of the first handle part 3B across the center 3R of the first handle part 3B in the direction of the motor rotation axis MX. The trigger switch 510 is configured such that the magnitude of the operating force for operating the trigger lever 510A is brought close to each other between the position of the pressing surface 511 on the upper end portion 3P side from the center of the first handle part 3B and the position of the pressing surface 511 on the lower end portion 3Q side from the center of the pressing surface 511.

According to the above-mentioned configuration, the difference in the operating force for operating the trigger lever 510A is reduced between the case where the position of the pressing surface 511 on the upper end portion 3P side from the center of the first handle part 3B is pulled and the case where the position of the pressing surface 511 on the lower end portion 3Q side from the center is pulled. Therefore, even when the direction of the hand of the operator holding the first handle part 3B is changed between the case where the rechargeable earth auger drill 1F is used in the vertical placement state to form the lateral hole and the case where the rechargeable earth auger drill 1F is used in the horizontal placement state to form the vertical hole, and the position at which the pulling operation of the trigger lever 510A is performed is changed, the difference in the operating force required for the pulling operation is reduced. Therefore, the operability of the rechargeable earth auger drill 1F can be improved.

In the present embodiment, the trigger switch 510 includes: the switch circuit 510B, which outputs an operation signal according to the operation of the trigger lever 510A; and the link mechanism 510C, which supports the trigger lever 510A to be movable according to the action of the operating force applied on the pressing surface 511.

According to the above-mentioned configuration, it is possible to easily realize a structure in which the trigger lever 510A is moved evenly between the case where the position on the upper end portion 3P side of the pressing surface 511 is operated and the case where the position on the lower end portion 3Q side is operated by the link mechanism 510C. Therefore, it is possible to effectively reduce the difference in the operating force required for the pulling operation on different positions of the pressing surface 511.

In the present embodiment, the link mechanism 510C supports the trigger lever 510A at the first support position on the upper end portion (one end portion) 3P side from the center 3R of the first handle part 3B and at the second support position on the lower end portion (the other end portion) 3Q side from the center 3R.

In the above configuration, it is possible to equalize the operating force required in a case where the position of the pressing surface 511 on the upper end portion 3P side from the center of the first handle part 3B is pulled and the operating force required in a case where the position thereof on the lower end portion 3Q side from the center is pulled.

### Seventh Embodiment

A seventh embodiment will be described. In the following description, the same or equivalent components as those of the above-described embodiments are denoted by the same reference numerals, and the description of the components is simplified or omitted.

### Rechargeable Earth Auger Drill

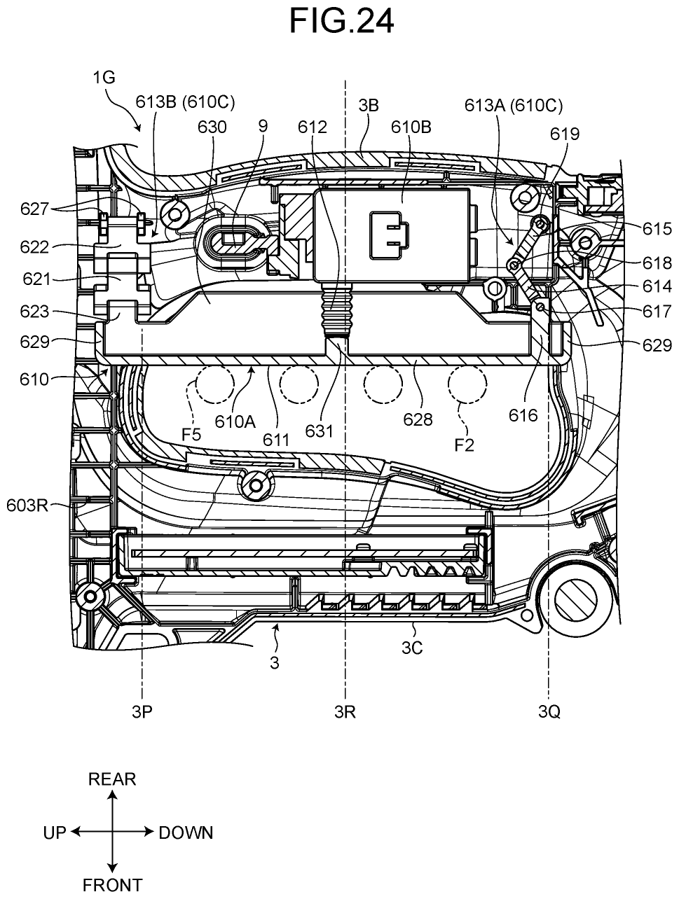

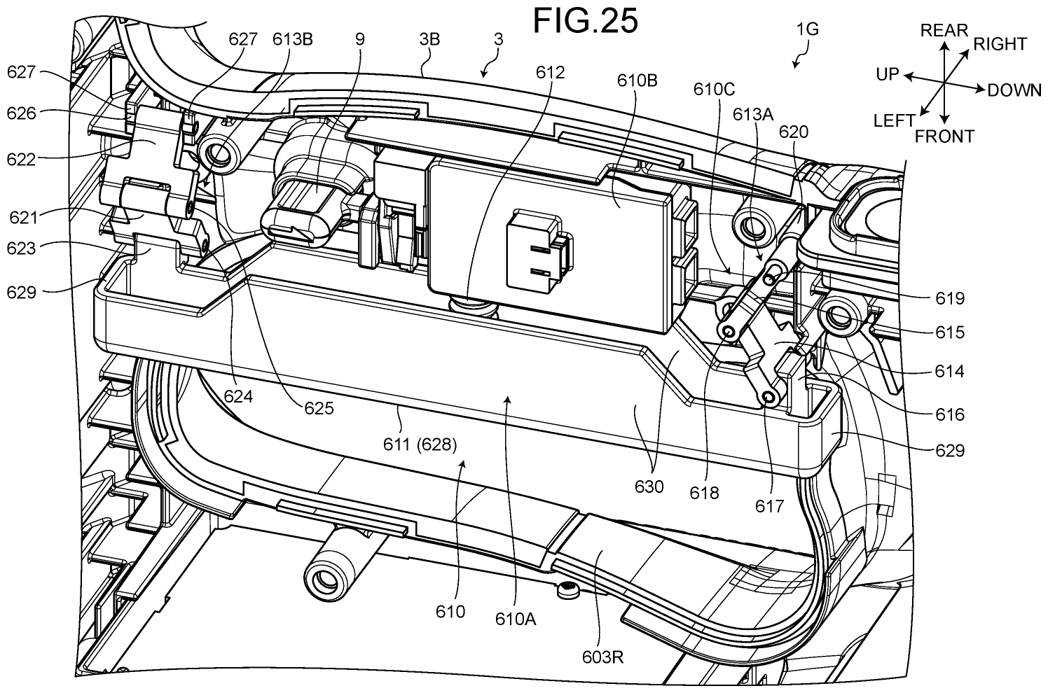

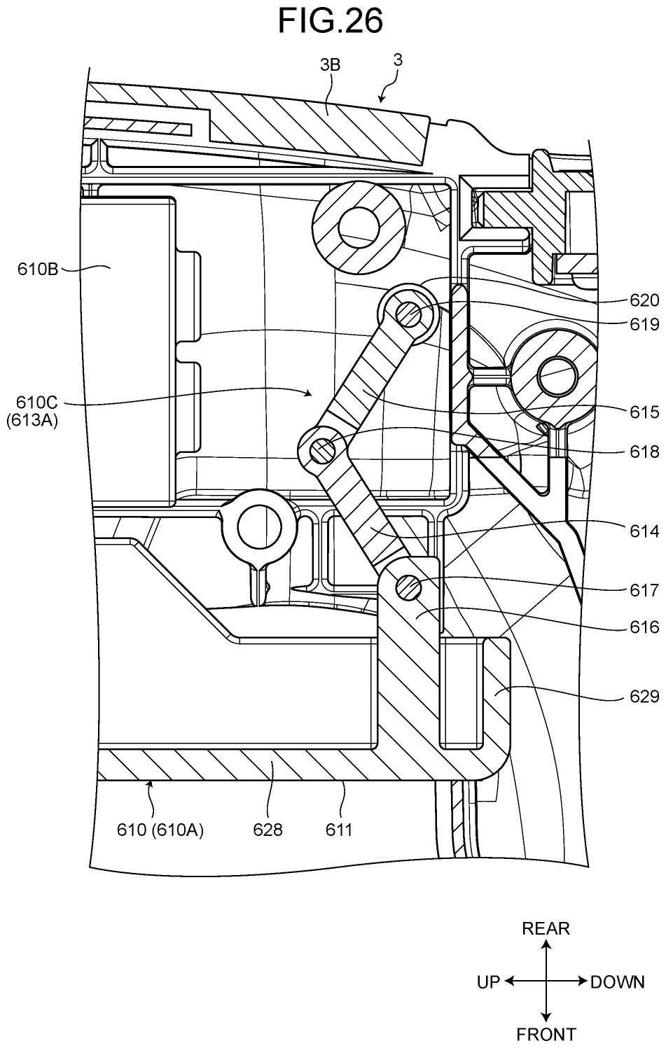

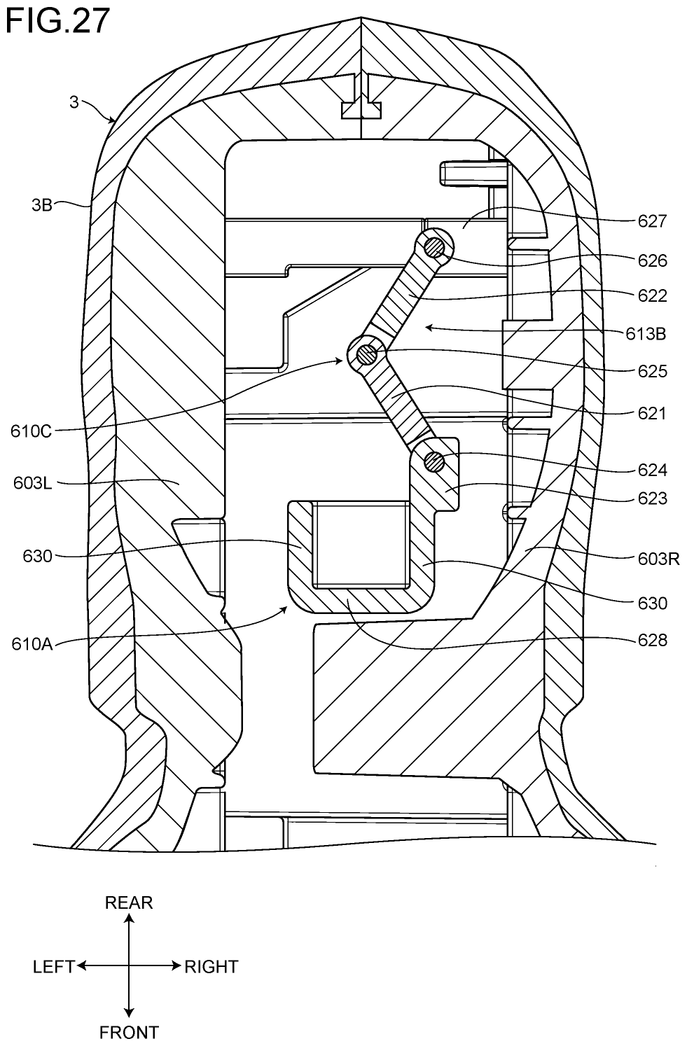

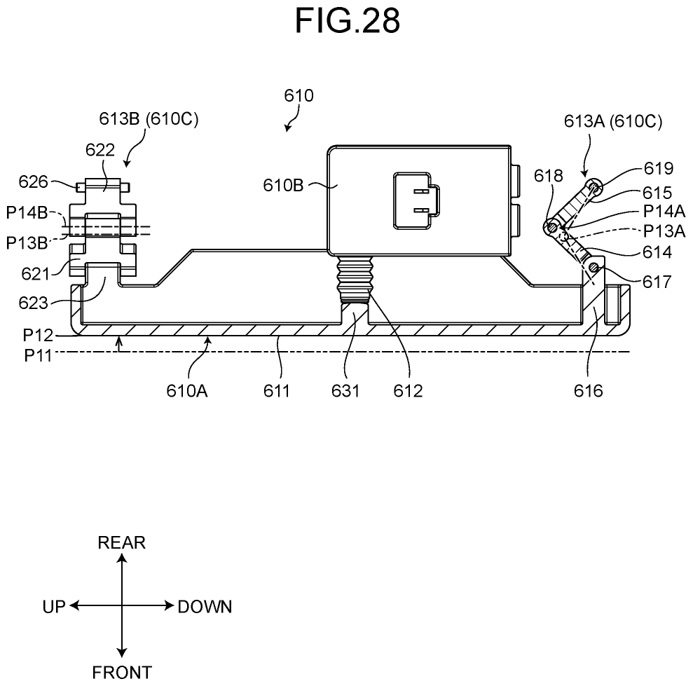

FIG. 24 is a cross-sectional view illustrating the inside of a first handle part 3B provided with a trigger switch 610 according to the seventh embodiment. FIG. 25 is a perspective view illustrating the inside of the first handle part 3B provided with the trigger switch 610 according to the seventh embodiment. FIG. 26 is a cross-sectional view of a first arm 613A of a link mechanism 610C according to the seventh embodiment taken along the front-rear direction. FIG. 27 is a cross-sectional view of a second arm 613B of the link mechanism 610C according to the seventh embodiment taken along the left-right direction. FIG. 28 is a cross-sectional view illustrating a state in which a trigger lever 610A according to the seventh embodiment is pulled.

The rechargeable earth auger drill 1G according to the seventh embodiment has a structure different from that of the sixth embodiment, and brings the operating force necessary for the pulling operation close to each other on different positions. The trigger switch 610 is configured such that the magnitude of the operating force for operating the trigger lever 610A is brought close to each other between the position of the pressing surface 611 on the upper end portion (first end portion) 3P side from the center 3R of the handle part (first handle part 3B) and the position thereof on the lower end portion (second end portion) 3Q side from the center 3R.

The trigger switch 610 is operated by an operator to start the motor 8. The trigger switch 610 is provided on the handle housing part 3. The trigger switch 610 includes the trigger lever 610A, the switch circuit 610B, and the link mechanism 610C.

The trigger switch 610 is provided on the handle part of the handle housing part 3. The trigger switch 610 is provided in the first handle part 3B. The trigger lever 610A is disposed to protrude forward from the front portion of the first handle part 3B. When the trigger lever 610A is pulled rearward, the motor 8 is started.

The first handle part 3B has an internal space capable of housing the switch circuit 610B. The switch circuit 610B is housed in the first handle part 3B. The switch circuit 610B outputs operation signals when the trigger lever 610A is pulled. When the trigger lever 610A is pulled rearward in a state where the rechargeable earth auger drill 1G is activated, electric power is supplied from the battery pack 17 to the motor 8, and the motor 8 is started. The motor 8 is driven based on operation signals output from the switch circuit 610B. When the operation and the operation release of the trigger lever 610A are switched, the driving and the stopping of the motor 8 are switched.

In the up-down direction, one end portion (first end portion) of the trigger lever 610A is disposed on the upper end portion 3P side from the center 3R of the first handle part 3B. The other end portion (second end portion) of the trigger lever 610A is disposed on the lower end portion 3Q from the center 3R of the first handle part 3B. In the present embodiment, the trigger lever 610A is provided to extend from the upper end portion 3P to the lower end portion 3Q of the first handle part 3B.

The trigger lever 610A has a pressing surface 611. The pressing surface 611 is a front surface of the trigger lever 610A. The pressing surface 611 extends along the first handle part 3B. The pressing surface 611 is formed over the upper end portion 3P side of the first handle part 3B across the center 3R of the first handle part 3B and the lower end portion 3Q side of the first handle part 3B across the center 3R of the first handle part 3B. In the present embodiment, the pressing surface 611 extends from the upper end portion 3P of the first handle part 3B to the lower end portion 3Q of the first handle part 3B. The pressing surface 611 is continuous from the upper end portion 3P to the lower end portion 3Q of the first handle part 3B.

The trigger lever 610A has: a front surface 628 on which the pressing surface 611 is formed; upper and lower side surfaces 629, which are both surfaces in the up-down direction; and left and right side surfaces 630, which are both surfaces in the left-right direction. The trigger lever 610A has a lever protrusion 631 that comes into contact with the switch circuit 610B. The lever protrusion 631 protrudes rearward from a rear surface (a surface opposite to the pressing surface 611) of the front surface 628. The lever protrusion 631 is disposed forward of the actuating part 612 of the switch circuit 610B. The lever protrusion 631 faces the actuating part 612 in the front-rear direction.

The switch circuit 610B is disposed near the center 3R of the first handle part 3B in the up-down direction. The switch circuit 610B includes the actuating part 612 that is moved by a pulling operation. The actuating part 612 moves forward and rearward in the front-rear direction. The actuating part 612 is biased forward by a biasing member built in the switch circuit 610B. When the actuating part 612 moves rearward from the forward limit, an input operation to the switch circuit 610B is performed. The actuating part 612 is disposed near the center 3R of the first handle part 3B in the up-down direction. The actuating part 612 is closer to the center 3R than the upper end portion 3P of the first handle part 3B. The actuating part 612 is closer to the center 3R than the lower end portion 3Q of the first handle part 3B. The actuating part 612 and the lever protrusion 631 are arranged at the center of the trigger lever 610A in the up-down direction.

The forward/reverse switching lever 9 is disposed in the first handle part 3B. The forward/reverse switching lever 9 is movable in the left-right direction. The forward/reverse switching lever 9 is movable to three positions of a position on one side and a position on the other side in the left-right direction, and an intermediate position. The forward/reverse switching lever 9 is connected to the switch circuit 610B. In response to the forward/reverse switching lever 9 being disposed at the position on one side, the switch circuit 610B is switched to the forward rotation state. In response to the forward/reverse switching lever 9 being disposed at the position on the other side, the switch circuit 610B is switched to the reverse rotation state. In response to the forward/reverse switching lever 9 being disposed at the intermediate position, the switch circuit 610B is switched to the locked state. When the switch circuit 610B is in the forward rotation state, the motor 8 is driven to rotate forward by the pulling operation. When the switch circuit 610B is in the reverse rotation state, the motor 8 is reversely driven by the pulling operation. When the switch circuit 610B is in the locked state, the trigger lever 610A is fixed. Therefore, when the forward/reverse switching lever 9 is at the intermediate position, the trigger lever 610A does not move even if the operator performs the pulling operation.

At least a part of the link mechanism 610C is housed in the first handle part 3B. The link mechanism 610C is operably provided in the first handle part 3B. The link mechanism 610C supports the trigger lever 610A to be movable according to the action of the operating force on the pressing surface 611. The link mechanism 610C receives an operating force by the pulling operation via the trigger lever 610A. As a result, the link mechanism 610C and the trigger lever 610A move in conjunction with each other. The link mechanism 610C is not in contact with the actuating part 612. The lever protrusion 631 of the trigger lever 610A presses the actuating part 612 rearward in accordance with the pulling operation. An input to the switch circuit 610B is executed by the rearward movement of the actuating part 612.

The link mechanism 610C includes a first arm 613A and a second arm 613B. The link mechanism 610C according to the present embodiment is a Sarrus link mechanism that translationally supports the trigger lever 610A. The link mechanism 610C supports the trigger lever 610A to be translationally movable with respect to the switch circuit 610B without the guide part 535 described in the sixth embodiment. Also in the seventh embodiment, a guide part that guides the trigger lever 610A to translate may be provided. The first arm 613A and the second arm 613B are connected to different positions of the trigger lever 610A. The first arm 613A and the second arm 613B move in different directions. Each arm (first arm 613A, second arm 613B) of the link mechanism 610C is foldable by a plurality of links connected by a hinge shaft.

The first arm 613A is disposed on the lower end portion 3Q side of the first handle part 3B with respect to the actuating part 612 of the switch circuit 610B. The first arm 613A is closer to the lower end portion 3Q than the center 3R of the first handle part 3B. The first arm 613A is connected to a portion (connection projection 616) on the lower end side of the trigger lever 610A. The first arm 613A includes a first link 614 and a second link 615.

The first link 614 is connected to the trigger lever 610A and the second link 615. The first link 614 has a flat plate shape. The first link 614 is connected to the connection projection 616 protruding rearward from the front surface 628 of the trigger lever 610A. The connection projection 616 is provided at a position of the trigger lever 610A on the lower end portion 3Q side from the center 3R of the first handle part 3B. The first link 614 and the connection projection 616 are rotatably connected by a trigger shaft 617 extending in the left-right direction. The connection projection 616 has an insertion hole through which the trigger shaft 617 is inserted. One end portion of the first link 614 branches into a Y shape and is disposed on both sides of the connection projection 616 in the left-right direction. The first link 614 holds both ends of the trigger shaft 617 on both sides of the connection projection 616. The other end portion of the first link 614 has an insertion hole through which the hinge shaft 618 is inserted.

The second link 615 is connected to the first link 614 and the pivot shaft 619. The second link 615 has a flat plate shape. The second link 615 and the first link 614 are rotatably connected by a hinge shaft 618 extending in the left-right direction. One end portion of the second link 615 branches into a Y shape and is disposed on both sides of the other end portion of the first link 614 in the left-right direction. The second link 615 holds both ends of the hinge shaft 618 on both sides of the other end portion of the first link 614. The other end portion of the second link 615 has an insertion hole through which the pivot shaft 619 is inserted.

The second link 615 is rotatably supported by the pivot shaft 619. The pivot shaft 619 is a shaft member mounted on the first handle part 3B and extending in the left-right direction. The pivot shaft 619 passes through an insertion hole formed at the other end portion of the second link 615. Both end portions of the pivot shaft 619 are respectively supported by the boss parts 620. The boss part 620 is formed on each of the right inner surface and the left inner surface of the first handle part 3B.

In this manner, the first arm 613A includes two links and three joints. The first arm 613A can be folded by pivoting the two links in a plane along the up-down direction and the front-rear direction. The first arm 613A can expand and contract in the front-rear direction as a whole by the folding operation. As a result, the first arm 613A allows the trigger lever 610A to move in the front-rear direction. The first arm 613A is not rotatable in the left-right direction. The first arm 613A restrains the movement (translation and rotation) of the trigger lever 610A so that the trigger lever 610A cannot move in the left-right direction.

The second arm 613B is disposed on the upper end portion 3P side of the first handle part 3B with respect to the actuating part 612 of the switch circuit 610B. The second arm 613B is closer to the upper end portion 3P than the center 3R of the first handle part 3B. The second arm 613B is connected to a portion (connection projection 623) on the upper end side of the trigger lever 610A. The second arm 613B includes a first link 621 and a second link 622.

The first link 621 is connected to the trigger lever 610A and the second link 622. The first link 621 has a flat plate shape. The first link 621 is connected to the connection projection 623 projecting rearward from the left and right side surfaces 630 of the trigger lever 610A. The connection projection 623 is formed at the rear end portion of the right side surface of the trigger lever 610A. The connection projection 623 is provided at a position of the trigger lever 610A on the upper end portion 3P side from the center 3R of the first handle part 3B. The first link 621 and the connection projection 623 are rotatably connected by a trigger shaft 624 extending in the up-down direction. The connection projection 623 has an insertion hole through which the trigger shaft 624 is inserted. One end portion of the first link 621 branches into a Y shape and is disposed on both sides of the connection projection 623 in the up-down direction. The first link 621 holds both ends of the trigger shaft 624 on both sides of the connection projection 623. The other end portion of the first link 621 has an insertion hole through which the hinge shaft 625 is inserted.

The second link 622 is connected to the first link 621 and the pivot shaft 626. The second link 622 has a flat plate shape. The second link 622 and the first link 621 are rotatably connected by a hinge shaft 625 extending in the front-rear direction. One end portion of the second link 622 branches into a Y shape and is disposed on both sides of the other end portion of the first link 621 in the left-right direction. The second link 622 holds both ends of the hinge shaft 625 on both sides of the other end portion of the first link 621. The other end portion of the second link 622 has an insertion hole through which the pivot shaft 626 is inserted.

The second link 622 is rotatably supported by the pivot shaft 626. The pivot shaft 626 is a shaft member mounted on the first handle part 3B and extending in the up-down direction. The pivot shaft 626 passes through an insertion hole formed in the second link 622. Both end portions of the pivot shaft 626 are supported by a shaft support part 627. The shaft support part 627 is formed on a right inner surface of the first handle part 3B.

Specifically, the handle housing part 3 has a left-right split structure. The handle housing part 3 is divided into a left housing 603L and a right housing 603R. The shaft support part 627 is formed in the right housing 603R. The shaft support part 627 protrudes leftward from the inner surface of the right housing 603R. An insertion hole for holding the pivot shaft 626 is provided at a distal end portion of the shaft support part 627. Thus, the pivot shaft 626 holds the other end portion of the second link 622 to be vertically rotatable.

The second arm 613B includes two links and three joints. The second arm 613B can be folded by pivoting the two links in a plane along the left-right direction and the front-rear direction. The second arm 613B can expand and contract in the front-rear direction as a whole by the folding operation. As a result, the second arm 613B allows the trigger lever 610A to move in the front-rear direction. The second arm 613B is not rotatable in the up-down direction. The second arm 613B restrains the movement (translation and rotation) of the trigger lever 610A so that the trigger lever 610A cannot move in the up-down direction.

In this manner, the first arm 613A supports the trigger lever 610A at the position on the lower end portion 3Q side from the center 3R of the first handle part 3B. The second arm 613B supports the trigger lever 610A at the position on the upper end portion 3P side from the center 3R of the first handle part 3B. Therefore, the link mechanism 610C supports the trigger lever 610A at the first support position on the upper end portion (one end portion) 3P side from the center 3R of the first handle part 3B and at the second support position on the lower end portion (the other end portion) 3Q side from the center 3R. In addition, the first arm 613A supports the trigger lever 610A at the position on the lower end portion 3Q side from the switch circuit 610B. The second arm 613B supports the trigger lever 610A at the position on the upper end portion 3P side from the switch circuit 610B. Therefore, the switch circuit 610B is disposed between the first support position on the upper end portion (one end portion) 3P side and the second support position on the lower end portion (the other end portion) 3Q side of the trigger lever 610A by the link mechanism 610C.

The first arm 613A and the second arm 613B cooperatively allow the trigger lever 610A to move in the front-rear direction. The trigger lever 610A is restrained from moving in the left-right direction by the first arm 613A, and is restrained from moving in the up-down direction by the second arm 613B. As a result, the link mechanism 610C supports the trigger lever 610A to be translationally movable such that the trigger lever 610A is movable only in the front-rear direction. Therefore, the link mechanism 610C enables the trigger lever 610A to translate in the front-rear direction without the guide part.

As illustrated in FIG. 26, the hinge shaft 618 of the first arm 613A moves in a direction (upward direction) approaching the center of the trigger lever 610A along with the folding operation of the first arm 613A. Since the hinge shaft 618 does not protrude from the trigger lever 610A when the first arm 613A is folded, an installation space of the trigger switch 610 inside the handle housing part 3 becomes compact. The first arm 613A may be configured such that the hinge shaft 618 moves to the outside (in the downward direction) of the trigger lever 610A when folded. When the hinge shaft 618 moves to the outside (in the downward direction) of the trigger lever 610A, there is a possibility that the hinge shaft 618 protrudes to the outside (in the downward direction) of the upper and lower side surfaces 629 of the trigger lever 610A. In this case, an installation space of the trigger switch 610 in the handle housing part 3 increases. When the hinge shaft 618 moves to the outside (in the downward direction) of the trigger lever 610A, the hinge shaft 618 can be prevented from protruding from the trigger lever 610A by bringing the positions of the pivot shaft 619 and the connection projection 616 close to the center side (upward direction) of the trigger lever 610A.

As illustrated in FIG. 27, the second arm 613B connects the right housing 603R (shaft support part 627) and the left and right side surfaces 630 of the trigger lever 610A on the right side. The hinge shaft 625 of the second arm 613B moves in a direction (left direction) approaching the center of the trigger lever 610A along with the folding operation of the second arm 613B. Since the hinge shaft 625 does not protrude from the trigger lever 610A when the second arm 613B is folded, the installation space of the trigger switch 610 inside the handle housing part 3 becomes compact. The second arm 613B may be configured such that the hinge shaft 625 moves to the outside (in the right direction) of the trigger lever 610A when folded. In a case where the hinge shaft 625 moves to the outside (in the right direction) of the trigger lever 610A, there is a possibility that the hinge shaft 625 protrudes to the outside (in the right direction) of the trigger lever 610A when the second arm 613B is folded. In this case, the installation space of the trigger switch 610 inside the handle housing part 3 increases. The second arm 613B may be provided to connect the left housing 603L and the left and right side surfaces 630 on the left side of the trigger lever 610A. In this case, the shaft support part 627 is formed in the left housing 603L. In a case where the second arm 613B connects the left housing 603L and the left and right side surfaces 630 on the left side, when the hinge shaft 625 is moved to the center side (in the right direction) of the trigger lever 610A, it is possible to prevent the hinge shaft 625 from protruding outward from the trigger lever 610A.

When the trigger lever 610A is pulled, an operating force directed rearward is applied on the pressing surface 611 by the operator's fingers. The trigger lever 610A transmits the operating force to the first arm 613A and the second arm 613B. By the operating force, the first arm 613A and the second arm 613B are folded so that the length thereof in the front-rear direction decreases. The trigger lever 610A moves rearward toward the switch circuit 610B along with the folding operation of the first arm 613A and the second arm 613B. The trigger lever 610A moving rearward presses the actuating part 612 of the switch circuit 610B rearward by the lever protrusion 631. When the actuating part 612 is pushed and moved rearward, the switch circuit 610B outputs operation signals. As illustrated in FIG. 28, the trigger lever 610A moves from an initial position P11 to a rearward limit P12 by the pulling operation. The first arm 613A performs a folding operation such that the hinge shaft 618 is displaced from an initial position P13A to a position P14A. The second arm 613B performs a folding operation such that the hinge shaft 625 is displaced from an initial position P13B to a position P14B.

The link mechanism 610C linearly translates the trigger lever 610A rearward by restraining the movement of the trigger lever 610A in the left-right direction and the up-down direction. The link mechanism 610C evenly supports the rearward movement of the trigger lever 610A by the first arm 613A and the second arm 613B during the pulling operation. As a result, regardless of which of the position on the upper end portion 3P side and the position on the lower end portion 3Q side of the pressing surface 611 the operating force acts, the operating force required for the pulling operation (rearward movement) of the trigger lever 610A is equalized.

Therefore, in the present embodiment, the operating force required for the pulling operation of the trigger lever 610A is substantially equal regardless of which finger illustrated in FIG. 24 performs the pulling operation. More specifically, regardless of which position from one end portion to the other end portion of the pressing surface 611 serves as the pressing point, the operating force required for the pulling operation of the trigger lever 610A is substantially equal.

When the pulling operation is finished and the operating force is no longer applied, the actuating part 612 returns to the forward limit by the biasing member inside the switch circuit 610B. As the actuating part 612 returns to the forward limit, the lever protrusion 631 is pushed back and the trigger lever 610A returns to the initial position on the front side. The first arm 613A and the second arm 613B of the link mechanism 610C return to the initial positions on the front side while pivoting each link to be developed from the folded state along with the forward movement of the trigger lever 610A.

### Effects

As described above, in the present embodiment, the rechargeable earth auger drill 1G includes: the motor 8, which include the rotor 82 configured to rotate about the motor rotation axis MX; the motor housing part 2, which houses the motor 8; the trigger switch 610, which includes the trigger lever 610A to be operated to start the motor 8; the handle housing part 3, which is disposed on a first side with respect to the motor housing part 2 in the directions of the motor rotation axis MX and includes the handle part (first handle part 3B) in which the trigger switch 610 is provided; the speed reduction mechanism 14; the gear housing part 4, which is disposed on the second side with respect to the motor housing part 2 in the direction of the motor rotation axis MX and houses the speed reduction mechanism 14; and the rotation output part 5, which protrudes from the gear housing part 4 and rotates about the output rotation axis DX orthogonal to the motor rotation axis MX based on the rotational force transmitted from the motor 8 via the speed reduction mechanism 14. The trigger lever 610A has the pressing surface 611 formed over the upper end portion (first end portion) 3P side and the lower end portion (second end portion) 3Q side of the first handle part 3B across the center 3R of the first handle part 3B in the direction of the motor rotation axis MX. The trigger switch 610 is configured such that the magnitude of the operating force for operating the trigger lever 610A is brought close to each other between the position of the pressing surface 611 on the upper end portion 3P side from the center of the first handle part 3B and the position thereof on the lower end portion 3Q side from the center.

According to the above-mentioned configuration, the difference in the operating force for operating the trigger lever 610A is reduced between the case where the position of the pressing surface 611 on the upper end portion 3P side from the center of the first handle part 3B is pulled and the case where the position thereof on the lower end portion 3Q side from the center is pulled. Therefore, even when the direction of the hand of the operator holding the first handle part 3B is changed between the case where the rechargeable earth auger drill 1G is used in the vertical placement state to form the lateral hole and the case where the rechargeable earth auger drill 1G is used in the horizontal placement state to form the vertical hole, and the position at which the trigger lever 610A is pulled is changed, the difference in the operating force required for the pulling operation is reduced. Therefore, the operability of the rechargeable earth auger drill 1G can be improved.

In the present embodiment, the trigger switch 610 includes the switch circuit 610B that outputs an operation signal according to the operation of the trigger lever 610A, and the link mechanism 610C that supports the trigger lever 610A to be movable according to the action of the operating force on the pressing surface 611.

According to the above-mentioned configuration, it is possible to easily realize a structure in which the trigger lever 610A is moved evenly between the case where the position of the pressing surface 611 on the upper end portion 3P side is operated and the case where the position thereof on the lower end portion 3Q side is operated by the link mechanism 610C. Therefore, it is possible to effectively reduce the difference in the operating force required for the pulling operation on different positions of the pressing surface 611.

In the present embodiment, the link mechanism 610C supports the trigger lever 610A at the position on the upper end portion (one end portion) 3P side from the center 3R of the first handle part 3B and at the position on the lower end portion (the other end portion) 3Q side from the center 3R.

According to the above-mentioned configuration, it is possible to equalize the operating force required in a case where the position of the pressing surface 611 on the upper end portion 3P side from the center of the first handle part 3B is pulled and the operating force required in a case where the position thereof on the lower end portion 3Q side from the center is pulled.

In the present embodiment, the switch circuit 610B is disposed between a support position on the upper end portion (one end portion) 3P side of the trigger lever 610A by the link mechanism 610C and a support position on the lower end portion (the other end portion) 3Q side. The link mechanism 610C includes the arm (first arm 613A, second arm 613B) foldable by a plurality of links (first link 614, second link 615, first link 621, and second link 622) connected by a hinge shaft (618, 625). The hinge shaft (618, 625) moves in a direction approaching the center of the trigger lever 610A along with the folding operation of the arm.

According to the above-mentioned configuration, since the switch circuit 610B and the link mechanism 610C are prevented from protruding to the outside of the trigger lever 610A, even when the trigger switch 610 including the link mechanism 610C is provided, the trigger switch 610 can be downsized.

### Other Embodiments

In the above-described embodiment, the power supply part is the battery mounting part 7 on which the battery pack 17 is mounted. The power supply part may be a cord connected to a commercial power source.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A rechargeable angle drill comprising:
a motor, which includes a rotor configured to rotate about a motor rotation axis, the motor rotation axis extending in an up-down direction;
a motor housing part, which houses the motor;
a trigger lever, which is operated to start the motor;
a handle housing part, which is disposed upward of the motor housing part and in which the trigger lever is provided;
a speed reduction mechanism;
a gear housing part, which is disposed downward of the motor housing part and houses the speed reduction mechanism; and
a rotation output part, which protrudes forward from the gear housing part and rotates about an output rotation axis orthogonal to the motor rotation axis based on a rotational force transmitted from the motor via the speed reduction mechanism, wherein
the trigger lever is disposed upward of a center of the handle housing part in the up-down direction.

2. The rechargeable angle drill according to claim 1, further comprising
a power supply part, which is provided upward of the handle housing part and supplies power to the motor.

3. The rechargeable angle drill according to claim 2, further comprising
a battery mounting part, which is provided upward of the handle housing part and to which a battery pack is detachably attached, wherein
the power supply part includes the battery mounting part.

4. The rechargeable angle drill according to claim 3, further comprising
a battery holding housing part in which the battery mounting part is provided, wherein
the handle housing part includes
a first handle part, which is connected to each of the motor housing part and the battery holding housing part, and
a second handle part, which is disposed forward of the first handle part and connected to each of the motor housing part and the battery holding housing part, and
the trigger lever is provided in the first handle part.

5. The rechargeable angle drill according to claim 4, wherein
the trigger lever is disposed to protrude forward from a front portion of the first handle part, and
the motor is started when the trigger lever is pulled rearward.

6. The rechargeable angle drill according to claim 4, further comprising
a forward/reverse switching lever, which is disposed upward of the trigger lever and operated to change a rotation direction of the motor.

7. The rechargeable angle drill according to claim 6, wherein the forward/reverse switching lever is disposed in the battery holding housing part.

8. A rechargeable angle drill comprising:
a motor, which includes a rotor configured to rotate about a motor rotation axis, the motor rotation axis extending in an up-down direction;
a motor housing part, which houses the motor;
a trigger lever, which is operated to start the motor;
a handle housing part, which is disposed upward of the motor housing part and in which the trigger lever is provided;
a battery holding housing part, which is provided upward of the handle housing part;
a speed reduction mechanism;
a gear housing part, which is disposed downward of the motor housing part and houses the speed reduction mechanism; and
a rotation output part, which protrudes forward from the gear housing part and rotates about an output rotation axis orthogonal to the motor rotation axis based on a rotational force transmitted from the motor via the speed reduction mechanism, wherein
the handle housing part includes
a first handle part, which is connected to each of the motor housing part and the battery holding housing part, and
a second handle part, which is disposed forward of the first handle part and connected to each of the motor housing part and the battery holding housing part,
the trigger lever is provided in the first handle part, and
in the up-down direction, the trigger lever is operated to pivot about a pivot shaft of the trigger lever defined upward of a center of the handle housing part.

9. The rechargeable angle drill according to claim 8, wherein
an upper end portion of the trigger lever is disposed upward of the center of the handle housing part,
a lower end portion of the trigger lever is disposed downward of the center of the handle housing part, and
the pivot shaft of the trigger lever is defined at the upper end portion of the trigger lever.

10. The rechargeable angle drill according to claim 9, further comprising
a power supply part, which is provided upward of the handle housing part and supplies power to the motor.

11. The rechargeable angle drill according to claim 10, further comprising
a battery mounting part, which is provided upward of the handle housing part and to which a battery pack is detachably attached, wherein
the power supply part includes the battery mounting part.

12. The rechargeable angle drill according to claim 11, wherein
the trigger lever is disposed to protrude forward from a front portion of the first handle part, and
the motor is started when the lower end portion of the trigger lever is pulled rearward.

13. A rechargeable angle drill comprising:
a motor, which includes a rotor configured to rotate about a motor rotation axis, the motor rotation axis extending in an up-down direction;
a motor housing part, which houses the motor;
a first trigger lever, which is operated to start the motor;
a handle housing part, which is disposed upward of the motor housing part and in which the first trigger lever is provided;
a speed reduction mechanism;
a gear housing part, which is disposed downward of the motor housing part and houses the speed reduction mechanism;
a rotation output part, which protrudes forward from the gear housing part and rotates about an output rotation axis orthogonal to the motor rotation axis based on a rotational force transmitted from the motor via the speed reduction mechanism;
an attachment housing part, which is mounted to the handle housing part;
a second trigger lever, which is provided in the attachment housing part; and
a coupling mechanism, which is housed in the attachment housing part and couples the second trigger lever and the first trigger lever, wherein
the first trigger lever is operated via the coupling mechanism by operating the second trigger lever.

14. The rechargeable angle drill according to claim 13, wherein
the attachment housing part includes
a connection part, which is connected to the handle housing part, and
a grip part, which extends downward from a rear portion of the connection part, and
the second trigger lever is disposed upward of a center of the grip part in the up-down direction.

15. The rechargeable angle drill according to claim 14, wherein the first trigger lever is disposed downward of a center of the handle housing part in the up-down direction.

16. The rechargeable angle drill according to claim 14, further comprising:
a battery mounting part, which is provided upward of the handle housing part and to which a battery pack is detachably attached; and
a battery holding housing part in which the battery mounting part is provided, wherein
the handle housing part includes
a first handle part, which is connected to each of the motor housing part and the battery holding housing part, and
a second handle part, which is disposed forward of the first handle part and connected to each of the motor housing part and the battery holding housing part,
the connection part includes
a first connection part, which is disposed rearward of the first handle part, and
a second connection part, which is disposed between the first handle part and the second handle part,
the grip part is provided to extend downward from the first connection part, and
the second trigger lever is disposed to protrude forward from a front portion of the grip part, and
the first trigger lever is operated by pulling the second trigger lever rearward.

17. A rechargeable earth auger drill comprising:
a motor, which includes a rotor configured to rotate about a motor rotation axis;
a motor housing part, which houses the motor;
a trigger switch, which includes a trigger lever to be operated to start the motor;
a handle housing part, which is disposed on a first side with respect to the motor housing part in a direction of the motor rotation axis and includes a handle part in which the trigger switch is provided;
a speed reduction mechanism;
a gear housing part, which is disposed on a second side with respect to the motor housing part in the direction of the motor rotation axis and houses the speed reduction mechanism; and
a rotation output part, which protrudes from the gear housing part and rotates about an output rotation axis orthogonal to the motor rotation axis based on a rotational force transmitted from the motor via the speed reduction mechanism, wherein
the trigger lever includes a pressing surface formed over a first end portion side and a second end portion side of the handle part across a center of the handle part in the direction of the motor rotation axis, and
the trigger switch is configured such that magnitude of an operating force for operating the trigger lever is brought close to each other between a position of the pressing surface on the first end portion side from the center of the handle part and a position of the pressing surface on the second end portion side from the center.

18. The rechargeable earth auger drill according to claim 17, wherein the trigger switch includes
a switch circuit, which outputs an operation signal in response to an operation of the trigger lever, and
a link mechanism, which supports the trigger lever to be movable according to an action of the operating force applied on the pressing surface.

19. The rechargeable earth auger drill according to claim 18, wherein the link mechanism supports the trigger lever at a first support position on the first end portion side from the center of the handle part and at a second support position on the second end portion side from the center.

20. The rechargeable earth auger drill according to claim 19, wherein
the switch circuit is disposed between the first support position on the first end portion side and the second support position on the second end portion side,
the link mechanism includes an arm foldable by a plurality of links connected by a hinge shaft, and
the hinge shaft is configured to move in a direction approaching a center of the trigger lever with a folding operation of the arm.
